(19) United States
(12) Patent Application Publication
(10) Pub. No.: US 2026/0289964 A1
(43) Pub. Date: Sep. 24, 2026

(54) SYSTEM

(71) Applicant: SoftBank Group Corp., Tokyo (JP)

(72) Inventor: Shunichi TAMURA, Tokyo (JP)

(73) Assignee: SoftBank Group Corp., Tokyo (JP)

(21) Appl. No.: 19/561,995

(22) Filed: Mar. 10, 2026

(30) Foreign Application Priority Data
Mar. 19, 2025 (JP) 2025-044991

(51) Int. Cl. G06V 10/764; G06N 3/0475; G06V 10/82; G10L 15/16; G10L 25/63

(52) U.S. Cl. CPC G06V 10/764; G06N 3/0475; G06V 10/82; G10L 15/16; G10L 25/63

(57) ABSTRACT

A system includes a processor that is configured to receive an inquiry from a user and generate a prompt sentence using a generative artificial intelligence model in order to analyze content of the inquiry, analyze voice data and image data by combining a voice processing technique and an image processing technique, extract feature information from the voice data and the image data, and identify a lost property based on the feature information, and analyze an emotion of the user and generate a response based on an emotional state of the user.

### CROSS-REFERENCE TO RELATED APPLICATION

This application is based on and claims priority under 35 USC 119 from Japanese Patent Application No. 2025-044991 filed on Mar. 19, 2025, the disclosure of which is incorporated by reference herein.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

Conventional lost-property management systems mainly rely on simple keyword searches or manual matching operations performed by staff members. In such systems, a user is typically required to input strictly formatted information, such as an item category, date, and location, and therefore it is difficult for the user to make an inquiry in natural language or in a conversational manner. In addition, these systems generally do not effectively utilize multimodal information such as voice data and image data provided by the user, and are unable to automatically extract and use detailed feature information of the lost property. Furthermore, conventional systems do not consider an emotional state of the user, and therefore cannot generate a response that is adapted to the user's emotion, which may lead to user dissatisfaction, especially in situations where the user is anxious or distressed about the lost property. Accordingly, there is a need for a system that can accurately interpret a user inquiry expressed in natural language, effectively analyze voice data and image data to identify lost property based on extracted feature information, and generate responses tailored to an emotional state of the user, thereby improving search accuracy and user experience.

### SUMMARY

In order to solve the above-described problems, a system according to the present invention comprises a processor, wherein the processor is configured to receive an inquiry from a user and generate a prompt sentence using a generative artificial intelligence model in order to analyze content of the inquiry. By utilizing the generative artificial intelligence model, the processor is able to interpret natural-language and conversational inquiries from the user and convert such inquiries into structured information suitable for subsequent processing. The processor is further configured to analyze voice data and image data by combining a voice processing technique and an image processing technique, extract feature information from the voice data and the image data, and identify a lost property based on the feature information. Through this configuration, the system can use multimodal information supplied by the user to accurately determine characteristics of the lost property and improve the precision of identification. Moreover, the processor is configured to analyze an emotion of the user and generate a response based on an emotional state of the user. By detecting and considering the user's emotional state, the system can generate responses that are linguistically and emotionally appropriate, thereby enhancing user satisfaction. In certain embodiments, the processor is configured to generate an appropriate answer based on the content of the inquiry from the user, and, in further embodiments, the processor is configured to analyze the voice data and the image data to extract the feature information and identify the lost property based on the feature information.

The term “system” refers to an arrangement of one or more hardware and software components that cooperate to execute processing for handling user inquiries, analyzing multimodal data, and generating responses, and may be implemented on a single device or distributed across multiple devices connected via a network.

The term “processor” refers to any hardware device or combination of hardware and software, such as a CPU, GPU, ASIC, FPGA, or microcontroller, that executes instructions to perform operations including receiving user inquiries, interacting with artificial intelligence models, analyzing data, and generating responses.

The term “inquiry” refers to any request, question, or statement provided by a user for the purpose of searching for, identifying, or obtaining information about a lost property, and may be expressed in natural language text, speech, or in combination with other data such as images.

The term “prompt sentence” refers to a text sequence generated by the processor for input to a generative artificial intelligence model, the text sequence including instructions, context, and content derived from the user's inquiry so that the generative artificial intelligence model can analyze and interpret the inquiry.

The term “generative artificial intelligence model” refers to a machine learning model, such as a large language model or generative neural network, that is capable of processing the prompt sentence and generating outputs including analyses, interpretations, or structured data based on the content of the user's inquiry.

The term “voice data” refers to audio signals representing speech uttered by the user or other persons, the signals being captured by a microphone or other audio input device and processed in digital form by the system.

The term “image data” refers to digital data representing a still image or a frame of a video, the image including at least a visual representation of an object or scene relevant to a lost property, and being captured by a camera or other imaging device.

The term “voice processing technique” refers to any algorithm or method applied to voice data, including but not limited to speech recognition, speaker identification, noise reduction, and feature extraction, for the purpose of deriving information from the voice data relevant to the user's inquiry or to the characterization of the lost property.

The term “image processing technique” refers to any algorithm or method applied to image data, including but not limited to object detection, classification, segmentation, color analysis, and feature extraction, for the purpose of deriving information from the image data relevant to the user's inquiry or to the characterization of the lost property.

The term “feature information” refers to information extracted from voice data, image data, or other input data that describes characteristics of an object or context, such characteristics including, for example, shape, color, size, pattern, type, or other attributes used to identify a lost property.

The term “lost property” refers to any item that has been misplaced, forgotten, or left behind by an owner or user and is subject to being searched for, identified, or claimed through the system.

The term “emotion” refers to an affective state of the user, such as anxiety, anger, relief, sadness, or satisfaction, which can be inferred from textual expressions, voice characteristics, facial expressions in images, or other behavioral indicators.

The term “emotional state” refers to a classification or representation of the user's emotion at a particular time, determined or estimated by the processor based on analysis of the user's inputs, and used as a basis for selecting or generating an appropriate response.

The term “response” refers to any output provided by the system to the user, including but not limited to textual messages, spoken messages, recommendations of candidate lost properties, confirmations, or guidance, the content and tone of which may be adapted based on the emotional state of the user and the analysis of the inquiry.

The term “appropriate answer” refers to a response generated by the processor that addresses the content of the user's inquiry, including information about candidate lost properties, search results, system actions, or instructions, and is determined to be suitable in view of the interpreted intent of the user and, optionally, the user's emotional state.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

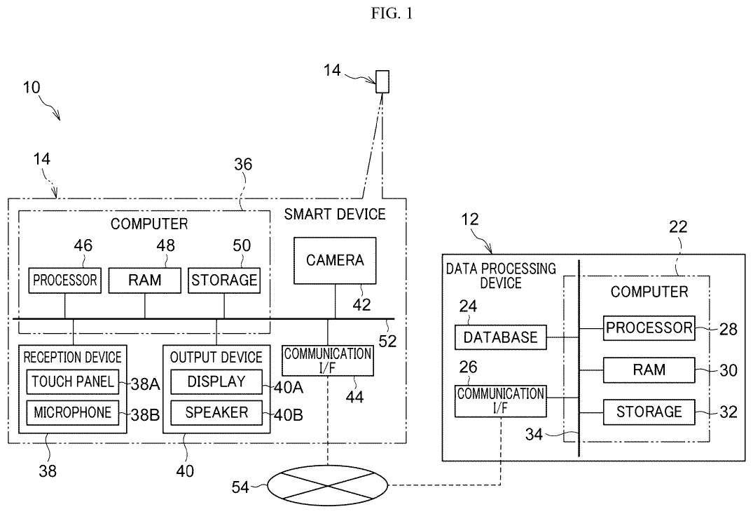

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

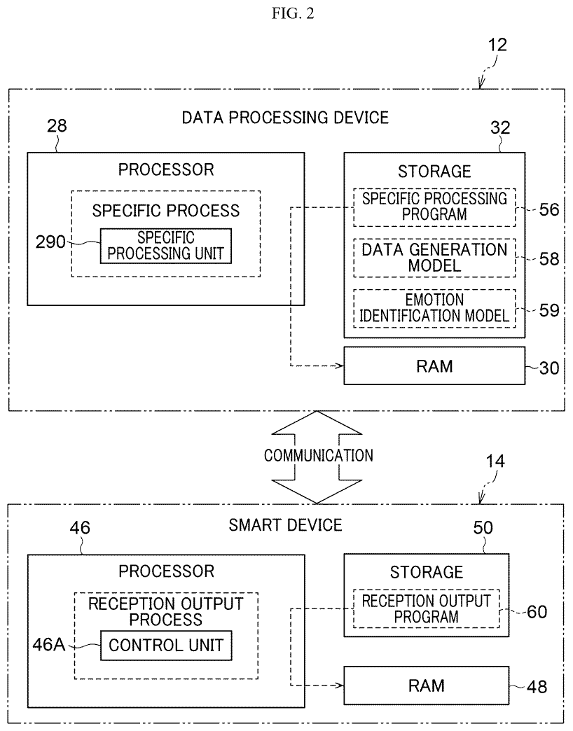

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

Conventional lost-and-found management systems typically rely on rigid, keyword-based search engines and static rule-based parsers running on general-purpose computer hardware. In such systems, a server receives a user's inquiry as plain text and applies predetermined string matching or pattern matching logic to search a found-article database. These approaches have several technical limitations from the viewpoint of computer technology.

First, conventional parsers often fail to correctly interpret diverse natural language expressions, such as relative time expressions (“yesterday,” “last Friday”) and informal descriptions of items (“my small blue wallet,” “the red folding umbrella I left at the station”). As a result, the server constructs incomplete or inaccurate search conditions, which leads to low retrieval accuracy from the database and forces users to reformulate queries repeatedly. This degrades the overall efficiency of the computing system and wastes processor and network resources due to unnecessary repeated queries.

Second, many existing systems treat voice data and image data merely as attachments, without deeply integrating them into the search logic. Even when a speech recognition module or an image recognition module is present, the recognized text or extracted attributes are not systematically fused with the text inquiry in a unified representation that can drive database searching. Consequently, the server cannot fully exploit multimodal input to refine search conditions, and the computing resources used for voice and image analysis do not translate into improved retrieval performance.

Third, relative time expressions and loosely specified item descriptions are often passed directly to the database layer as literal values or ad-hoc filters. Because the database engine is not designed to interpret human-oriented temporal expressions or semantically rich descriptions, the query execution plan remains sub-optimal. The server may issue broad or poorly constrained queries, causing unnecessary scanning of database records, increased processor load, and higher latency.

Fourth, when the server attempts to generate responses for the user, conventional systems either output raw database records or use fixed templates, which do not adapt well to the context of the inquiry. This makes it difficult for the user to quickly determine whether a retrieved record actually corresponds to the lost item. From a technical standpoint, this means that the presentation layer does not leverage the available structured information to optimize how information is filtered and summarized, leading to redundant data transfer and increased user-side processing effort.

Accordingly, there is a need for a computer-implemented technique in which a server uses a generative artificial intelligence model, controlled by carefully designed prompt sentences, to (i) convert heterogeneous user inputs (text, voice, image) into structured information including normalized time and item attributes, (ii) automatically transform such structured information into precise database search conditions, and (iii) generate context-appropriate natural language responses. Such a technique should improve how the processor allocates computation between natural language understanding, multimodal analysis, and database querying, thereby enhancing retrieval accuracy, reducing unnecessary database access, and lowering end-to-end response time in a lost-and-found environment.

The specific processing by the specific processing unit 290 of the data processing device 12 in Example 1 is realized by the following means.

The present invention provides a server comprising a processor configured to receive, via a communication terminal, natural language inquiry data, voice data, or image data from a user; to convert the inquiry data into text data, including by performing speech recognition on the voice data and by extracting attribute information from the image data; to generate a prompt sentence instructing a generative artificial intelligence model to extract date information, article category information, color information, place information, and feature information from the text data and the attribute information; to supply the prompt sentence together with the text data and the attribute information to the generative artificial intelligence model and obtain structured information including the date information, the article category information, the color information, the place information, and the feature information; to normalize the date information into absolute date-time information based on server time and time zone information when the date information is expressed as a relative time expression; to generate search conditions for a found-article management database based on the structured information including the normalized date-time information; to search found-article information stored in the found-article management database using the search conditions; and to generate response information including a description text or a summary text in natural language for presentation to the user by causing the generative artificial intelligence model to generate the description text or the summary text based on the structured information and the searched found-article information. This enables the server to technically improve the construction of database queries from heterogeneous user inputs, to reduce unnecessary database access by using normalized temporal expressions and precise item attributes, and to generate context-appropriate natural language responses, thereby enhancing retrieval accuracy and processing efficiency in a computer-implemented lost-and-found management system.

The term “system” refers to an arrangement of hardware resources and software resources that cooperatively execute processing for receiving inquiries from a user, processing the inquiries, accessing a database storing found-article information, and returning responses to the user.

The term “processor” refers to an electronic circuit or computing unit, such as a central processing unit or a processing core, configured to execute instructions of a program to perform operations including data reception, data analysis, interaction with a generative artificial intelligence model, database querying, and response generation.

The term “communication terminal” refers to an information processing device operated by a user, such as a mobile device, a portable device, or a stationary device, that is configured to transmit inquiry data to the server and to receive response information from the server over a communication network.

The term “user” refers to an individual or an organization operating the communication terminal to submit an inquiry regarding a lost article and to receive information relating to a found article.

The term “inquiry data” refers to information representing a user's request regarding a lost article, the information including at least one of text information, voice information, and image information that describes circumstances of loss or features of the article.

The term “natural language inquiry data” refers to inquiry data expressed in a human language, such as a sentence or phrase, which can include relative time expressions, item descriptions, and place descriptions.

The term “voice data” refers to digital audio information representing speech uttered by the user, including spoken descriptions of a lost article or circumstances surrounding the loss.

The term “image data” refers to digital visual information, such as a still image or a video frame, depicting an article or an environment related to the lost article.

The term “text data” refers to character-based information in a machine-readable format obtained from the user's direct text input, from transcription of voice data, or from analysis of image data.

The term “generative artificial intelligence model” refers to a data-driven computational model that generates new information, such as structured data, explanatory text, or summary text, based on input data and prompt sentences, and that is trained using machine learning or deep learning techniques.

The term “prompt sentence” refers to a sequence of characters or instructions supplied to the generative artificial intelligence model that specifies a desired task, such as extraction of structured information or generation of a description text, and that controls the behavior of the generative artificial intelligence model.

The term “structured information” refers to information represented in a predetermined data structure, such as fields or key-value pairs, including at least date information, article category information, color information, place information, and feature information extracted from inquiry data.

The term “date information” refers to information representing a point in time or a period related to the loss or discovery of an article, including an absolute date-time expression or a relative time expression.

The term “article category information” refers to information indicating a classification of an article, such as a general type or class of item, which is used as a criterion for searching found-article information.

The term “color information” refers to information indicating a color or a color group associated with an article, which is used as an attribute for distinguishing one article from another.

The term “place information” refers to information indicating a geographical location or a facility-level location associated with the loss or discovery of an article, including station areas, buildings, or other predefined locations.

The term “feature information” refers to information indicating characteristics of an article other than category and color, such as shape, size, brand, pattern, or other visual, textual, or contextual attributes that distinguish one article from another.

The term “attribute information” refers to information derived from image data or other sources indicating properties of an article, including at least an article category, a color, and appearance-related features used to identify or distinguish the article.

The term “voice processing technique” refers to a computational method or algorithm executed by the processor for processing voice data, including at least speech recognition that converts voice data into text data.

The term “image processing technique” refers to a computational method or algorithm executed by the processor for processing image data, including at least detection or classification of objects, colors, and visual features contained in the image data.

The term “found-article management database” refers to a structured data storage system managed by a data management program and configured to store found-article information including at least article category, color, discovery date, discovery place, and storage location.

The term “found-article information” refers to information stored in the found-article management database that describes one or more found articles, including their attributes, discovery circumstances, and storage locations.

The term “search conditions” refers to constraints or criteria generated by the processor based on structured information, which are used to form a query for retrieving relevant found-article information from the found-article management database.

The term “inquiry statement” refers to a query expression or command, such as a database query, generated by the processor according to the search conditions, and supplied to the found-article management database to retrieve matching records.

The term “absolute date-time information” refers to date and time information expressed on a calendar and clock scale, including at least a specific year, month, day, and optionally hour, minute, and second, which is independent of relative expressions such as “yesterday” or “last week.”

The term “relative time expression” refers to a description of time that is defined by reference to a current time or another time, including expressions such as “yesterday,” “last Friday,” “two days ago,” or “next week.”

The term “server time” refers to time information maintained by a timekeeping function within the server, which is used as a reference to convert a relative time expression into absolute date-time information.

The term “time zone information” refers to information indicating an offset and time-zone rules applied to the server time for interpreting and normalizing date and time values.

The term “response information” refers to information generated by the processor for presentation to the user, including at least search results, explanation texts, and summary texts related to found-article information.

The term “description text” refers to a natural language text generated based on structured information and found-article information, which describes one or more candidate found articles in a manner understandable to the user.

The term “summary text” refers to a natural language text generated based on structured information and found-article information, which condenses multiple data elements into a concise explanation highlighting key attributes relevant to the user's inquiry.

The term “unified inquiry text” refers to a text expression that combines at least one of user-provided text data, text data generated from voice data, and explanatory text including attribute information extracted from image data, which is supplied to the generative artificial intelligence model as part of a prompt sentence.

The term “extraction accuracy” refers to a quantitative or qualitative measure of how correctly and completely the generative artificial intelligence model identifies and outputs structured information from the inquiry data according to a specified prompt sentence.

In one embodiment, a server executes a computer program on an information processing apparatus to implement a lost-and-found management system that cooperates with one or more terminals operated by users. The server uses a generative AI model controlled by carefully designed prompt sentences to convert heterogeneous user inputs into structured information, to generate optimized database queries, and to produce context-adaptive natural language responses. The server thereby improves internal computer operations, including natural language parsing accuracy, query construction efficiency, database access patterns, and overall processing latency, beyond what conventional rule-based or keyword-based systems achieve.

### A. Hardware and Software Configuration

The server uses general-purpose server hardware, such as a rack-mounted computer including one or more multicore CPUs, an optional GPU, a main memory, a storage device such as an SSD, and a network interface. The server runs an operating system such as a Unix-like operating system. On top of the operating system, the server executes one or more application server programs, for example implemented as a web application framework or an API server. The server uses a relational database management system, such as a SQL-based database, as a found-article management database. The database stores found-article information in one or more tables. One exemplary table includes columns such as: item_id, item_category, color, found_date, found_place_code, description, storage_place_code, and auxiliary attributes such as brand or size. The database engine uses indexes on at least found_date, item_category, and color, so that the server can perform indexed lookups and range scans based on query conditions derived from user inputs.

The server uses a generative AI model as a natural language model, for example a transformer-based neural network having an encoder-decoder or decoder-only architecture. The generative AI model includes multiple self-attention layers, feed-forward layers, and layer normalization operations. The model is trained on a large corpus of text data using a language modeling objective, such as minimizing a cross-entropy loss between predicted tokens and ground-truth tokens. In one embodiment, the generative AI model is additionally fine-tuned on domain-specific data for lost-and-found scenarios, using supervised learning on input-output pairs of user inquiries and corresponding structured labels (date, item category, color, place, and features). The server accesses the generative AI model either as a hosted model accessible via an API, or as a locally deployed model running on a GPU.

The server uses a speech recognition module as a voice processing component. In one embodiment, the speech recognition module is an end-to-end neural network, such as a sequence-to-sequence model or a connectionist temporal classification (CTC)-based model, that converts sampled audio waveforms into sequences of characters or tokens. The speech recognition module is trained using supervised learning to minimize an alignment-based loss between predicted token sequences and reference transcriptions.

The server uses an image processing module as an image analysis component. In one embodiment, the image processing module includes a convolutional neural network or a vision-transformer-based encoder trained to classify object categories and detect dominant colors from images. The image processing module may further include a feature extractor that outputs a vector representation of visual features. The server can use a classifier on top of the feature vector to output item category probabilities, color labels, and specific appearance attributes, such as “folding,” “long handle,” or “logo present.”

The terminal uses client-side hardware such as a smartphone, tablet, or personal computer. The terminal includes input devices such as a touch screen, a keyboard, a microphone, and a camera, and a display device such as an LCD panel. The terminal executes client software such as a web browser or a native application. The terminal communicates with the server over a network using a protocol such as HTTPS.

The user operates the terminal to input lost-item inquiries in text, voice, or image form. The user can view the server's responses on the terminal display.

### B. Data Structures and Internal Modules

The server uses internal data structures to represent and transform user inquiries. In one embodiment, the server represents a user inquiry as an object including:
(1) raw_text: a character string representing user-typed text or text recognized from speech;
(2) raw_audio_reference: a pointer to stored voice data when voice input is used;
(3) raw_image_reference: a pointer to stored image data when image input is used;
(4) parsed_fields: a structure containing fields such as date_candidate, item_category_candidate, color_candidate, place_candidate, and feature_candidate;
(5) normalized_fields: a structure containing fields date_normalized, item_category_code, color_code, place_code, and feature_list;
(6) query_conditions: a structure describing database search conditions, including comparison operators and value ranges.

The server logically divides the processing program into the following modules: a communication module, a speech recognition module, an image analysis module, a prompt generation module, a generative AI interface module, a normalization module, a query construction module, a database access module, and a response generation module. Each module uses the above data structures so that intermediate results are explicitly represented and can be reused or logged.

### C. Program Behavior and Data Processing

The server receives inquiry data from the terminal. When the user inputs text directly, the terminal sends plain text data to the server. When the user speaks into the terminal, the terminal records audio samples and sends digitized voice data. When the user uses the camera, the terminal captures an image and sends the image data.

The server uses the speech recognition module to convert voice data into text. The speech recognition module performs feature extraction on audio frames, for example computing Mel-frequency cepstral coefficients or log-mel spectrograms, and then applies a neural network to output token probabilities. The server decodes the token sequence using a beam search algorithm, yielding a transcription. The server assigns this transcription to the raw_text field of the inquiry object. Because the speech recognition module operates on numerical features and performs probabilistic decoding, the system can process a wide range of accents and noise conditions with higher robustness than simple phoneme matching.

The server uses the image analysis module to extract attribute information from the image data. The image analysis module resizes the image, normalizes pixel values, and inputs them into a model such as a convolutional network. The final layer outputs probabilities over a set of item categories (for example, umbrella, wallet, bag, electronic device) and a set of color labels. An additional feature head can output presence of patterns, such as stripes or polka dots. The server selects labels whose probabilities exceed predefined thresholds, and stores them in the attribute information structure. The server can also convert high-dimensional feature vectors into a small number of categorical attributes using clustering or dimensionality reduction techniques.

The server constructs a unified inquiry text by combining the raw_text and the attribute information. For example, if the recognized text is “I lost this at the station yesterday” and the attribute information includes an article category “umbrella” and a color “red,” the server generates an explanation such as:

“User lost a red umbrella at a station yesterday.”

The server passes this unified inquiry text to the prompt generation module.

The server generates prompt sentences for the generative AI model. The prompt generation module uses template-based rules stored in memory. One exemplary prompt sentence for extraction of structured information is:

User input: “I lost my blue wallet last Friday.

“You are a lost property inquiry analysis system.

Please extract the following information from the user's statement:

(1) Normalized date, (2) Item type, (3) Color, (4) Location information (if available), (5) Other characteristics.

“Output should be returned as Japanese text, one line per item.”

Another example of a prompt sentence for generating a search-oriented query formulation is:

“Based on the following user input, create a concise Japanese search phrase for the lost property database.

User input: I lost a blue wallet last Friday.”

The generative AI interface module supplies these prompt sentences and the unified inquiry text to the generative AI model. Internally, the generative AI model tokenizes the input text, applies multiple self-attention layers that compute attention weights between all token positions, and propagates information through feed-forward sublayers. The model outputs token sequences that represent extracted fields or generated descriptions. The server receives the output tokens, decodes them to text, and parses the text into the structured information fields. Because the model uses learned attention weights instead of fixed rules, the system can consistently interpret diverse expressions of time and item descriptions that would be difficult to handle with conventional pattern matching.

The server uses the normalization module to convert relative time expressions into absolute date-time information. The normalization module uses the server's system clock and stored time zone information. For example, if the current server time is “2026 Jan. 30 10:00 UTC+9” and the extracted date field is “last Friday,” the normalization module computes the corresponding calendar date, “2026 Jan. 23.” The module then stores “2026 Jan. 23” in the date normalized field and associates this value with a date range query condition for the found-article management database. This numeric normalization of temporal expressions allows the database to use indexing and range query optimization.

The server maps item category text to internal codes using a lookup table. For example, input strings such as “umbrella,” “folding umbrella,” and “parasol” may be mapped to a unified category code “ITEM_CAT_UMBRELLA.” The server similarly maps color words such as “navy,” “light blue,” and “blue” into a color code representing a color group. This mapping reduces redundancy in the database and improves the selectivity of query predicates.

The server uses the query construction module to convert the normalized_fields structure into a database query. The query construction module generates an SQL statement with conditions on item_category_code, color_code, found_date, and optionally found_place_code. Because the date has been normalized and mapped to a simple comparable value, and the item category and color are expressed as codes, the resulting SQL statement uses equality or range conditions that are compatible with index-based search. As a result, the database engine can use index scans instead of full table scans, which reduces input/output operations and improves latency.

The server uses the database access module to send the SQL query to the database engine and receive a result set. The result set includes records whose attributes match the structured information extracted from the user inquiry. The server can also apply post-filtering on the server side, using information that is more complex than simple database fields, such as free-text descriptions or a similarity metric computed between the unified inquiry text and stored descriptions.

The server uses the response generation module to create a natural language explanation of the search results. In one embodiment, the server generates another prompt sentence that instructs the generative AI model to summarize the top search results. An example prompt sentence is: “Based on the following lost property information, please create an explanatory text in Japanese for users.

Clearly include the date, location, color, and type of item.”

The server supplies the raw data of the retrieved records, converted to text form, together with this prompt sentence. The generative AI model outputs a summary text that the server sends to the terminal for display. By offloading the summarization step to the generative AI model, the server reduces the amount of data transferred to the terminal and presents the user with concise information that is easier to interpret.

### D. Technical Effects and Improvement of Computer Technology

The server improves computer technology in several ways. Because the server explicitly constructs prompt sentences and unified inquiry texts that encode multimodal attributes, the generative AI model receives a richer and more structured context. This non-conventional prompting strategy, in which attribute information from image analysis and normalized temporal expressions are explicitly integrated into the input, allows the model to produce more accurate structured information than a simple direct mapping from raw text. This reduces errors in downstream query construction, which in turn leads to more selective database queries and fewer unnecessary database accesses.

The server improves processing efficiency by converting relative time expressions into absolute date-time values before query execution. This preprocessing enables the database engine to use available indexes and to avoid scanning wide date ranges that would be required if relative expressions were handled as free text. As a result, the server reduces the amount of disk I/O and CPU time consumed by the database engine, directly improving throughput and latency. The server improves data management by mapping heterogeneous item and color descriptions to normalized codes. The mapping transforms a high-entropy textual space into a lower-dimensional coded space that is specifically designed to align with database schema and index structures. This transformation is not a mere automation of human classification; rather, it is implemented as a predefined code system and mapping algorithm that are optimized for efficient query evaluation and storage. Because of this normalization, the server can represent query predicates more compactly and avoid ambiguous or inconsistent textual filters.

The server achieves higher extraction accuracy by using a generative AI model trained with a domain-specific loss function. During model training, the server or an associated training apparatus defines a loss function that penalizes incorrect extraction of date, category, color, and place fields. For example, the training uses labeled examples of user inquiries and structured targets, and the loss includes per-field cross-entropy terms. The training process adjusts model weights via gradient descent so that attention patterns and internal representations become specialized for detecting these particular attributes. Consequently, at inference time, the model's computations—including attention distributions and activation patterns—are biased towards capturing features that are relevant for query construction, not just for generic language tasks. The server reduces communication load by summarizing search results into a concise natural language explanation. Instead of sending all raw database rows to the terminal, the server selects key attributes and converts them into an explanation text. Because the explanation text has smaller size than the raw rows, especially when many candidate items exist, the server reduces the number of bytes transferred over the network. This reduction contributes to lower network congestion and faster perceived response time.

The server uses internal intermediate representations and module boundaries that differ from conventional human workflows. For example, the server always passes queries to the generative AI model in the form of prompt sentences with explicit task instructions and structured expectations. A human operator would typically read a user message and manually look up items, without encoding the task in a machine-oriented prompt. The use of prompt sentences as a formal interface between modules allows the server to dynamically adjust the content and level of detail of intermediate texts, which is a specifically technical mechanism to control model behavior and downstream database operations.

In alternative embodiments, the server can adjust hyperparameters of the generative AI model, such as temperature, top-k, or top-p sampling parameters, depending on the type of task (extraction or summarization). For extraction tasks, the server sets a low temperature to encourage deterministic output, which improves reproducibility of structured fields. For summarization tasks, the server sets a slightly higher temperature to allow more natural phrasing.

These parameter controls constitute a technical tuning of the model's sampling algorithm to serve different roles within the system.

In another embodiment, the server stores historical pairs of user inquiries and successful retrieval results. The server can periodically retrain or fine-tune the generative AI model using these historical data, using a technique such as mini-batch gradient descent, to further adapt the model to actual usage patterns. The server can also apply data augmentation methods, such as paraphrasing user texts or adding noise to dates and colors, to increase the robustness of the model. This continuous learning process improves the model's internal representations and leads to steadily improved extraction accuracy and query performance over time.

### E. Variations and Alternative Implementations

In one variation, the server can incorporate an additional rule-based post-processor that verifies the consistency of the structured information output by the generative AI model. For example, if the extracted date falls outside a predefined system retention period for found articles, the server can adjust the date range or request a refined extraction by generating a follow-up prompt sentence. This hybrid configuration further reduces the risk of issuing ineffective queries. In another variation, the server can maintain multiple generative AI models with different capacities or domains. The server can select a smaller, faster model for simple queries and a larger, more capable model for complex queries that include ambiguous temporal or spatial references. This model selection is implemented by a decision algorithm that examines input length, language, and presence of multimodal attributes. By routing requests to different models, the server optimizes computational resource usage and further improves overall throughput. In yet another embodiment, the server can use the internal feature vector produced by the image analysis module not only for attribute classification, but also to compute similarity between a user's image and stored images of found articles. This similarity can be computed using a distance metric such as cosine similarity. The server can then re-rank database results based on visual similarity, thereby reducing ranking errors that would occur if only textual attributes were considered.

Through these embodiments, the server, the terminal, and the user cooperate in a way that yields technical improvements inside the computer system. The server processes heterogeneous user inputs, transforms them into normalized and coded formats specialized for database operations, and uses a generative AI model in a controlled and instrumented manner via prompt sentences.

As a result, the system achieves higher retrieval accuracy, faster response, reduced database load, and improved communication efficiency, thereby providing a concrete improvement in computer technology rather than a mere automation of human lost-and-found procedures.

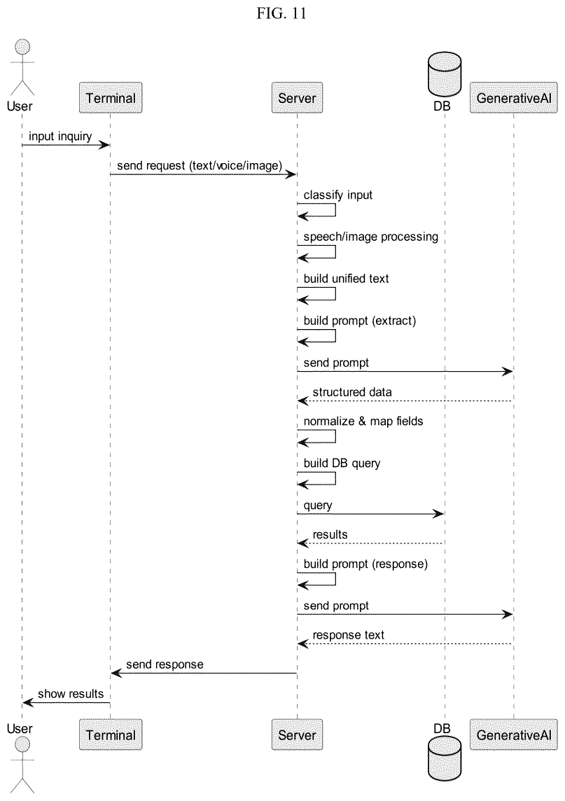

The following describes the processing flow using FIG. 11.

### Step 1:

User operates the terminal to input a lost-item inquiry.

User selects an input mode (text, voice, or image) on the terminal and provides inquiry content such as a sentence “I lost a blue wallet last Friday,” a spoken utterance with similar content, or an image of the lost article.

Input: human language description and/or an image of the lost article.

Output: digital input data on the terminal (UTF-8 text, audio file, or image file).

### Step 2:

Terminal generates a request message and transmits it to the server.

Terminal encodes the inquiry as request data including fields such as user identifier, input type (text/voice/image), and payload (text string, audio binary, or image binary), and sends this request to the server via HTTPS.

Input: user input data from Step 1.

Output: structured request message delivered over the network to the server.

### Step 3:

Server receives and classifies the inquiry request.

Server's communication module parses the HTTP headers and body, identifies the input type flag, stores the payload to temporary storage, and initializes an internal inquiry object indicating whether text, voice, and/or image data are present.

Input: structured request message from Step 2.

Output: internal inquiry object with raw_text (optional), raw_audio_reference (optional), and raw_image_reference (optional).

### Step 4:

Server performs speech recognition when voice data are included.

Server loads the voice processing module, reads the audio data from raw_audio_reference, converts the waveform into acoustic feature frames, and feeds them into a neural speech recognition model to decode a text transcription.

Input: raw_audio_reference within the inquiry object.

Data processing: feature extraction (e.g., spectrogram), neural inference, beam-search decoding.

Output: updated inquiry object with raw_text field containing transcribed text.

### Step 5:

Server performs image analysis when image data are included.

Server loads the image processing module, retrieves the image from raw_image_reference, resizes and normalizes the pixels, and inputs them into a visual recognition model that outputs item category probabilities, color labels, and appearance attributes.

Input: raw_image_reference within the inquiry object.

Data processing: convolution or attention-based feature extraction, classification, thresholding to select labels.

Output: attribute information (item category candidate, color candidate, feature list) stored in the inquiry object.

### Step 6:

Server composes a unified inquiry text incorporating multimodal attributes.

Server examines raw_text and attribute information; if both are available, server generates a combined explanatory sentence such as “User lost a red umbrella at a station yesterday” by inserting the category and color into a template; if only text exists, server uses the text as is.

Input: raw_text, attribute information from Steps 4 and 5.

Data processing: text concatenation, template filling, normalization of simple terms.

Output: unified inquiry text stored in the inquiry object.

### Step 7:

Server constructs a prompt sentence for structured information extraction.

Server's prompt generation module selects a predefined template for extraction and embeds the unified inquiry text inside the template to produce a complete prompt sentence that instructs the generative AI model which fields to extract.

Example prompt sentence:

User input: “I lost my blue wallet last Friday.”

“You are a lost property inquiry analysis system.

Extract the following information from the user's sentence:

(1) Normalized date, (2) Item type, (3) Color, (4) Location information (if available), (5) Other characteristics.

Output each item on a separate line in Japanese text.”

Input: unified inquiry text from Step 6.

Data processing: template selection, string insertion, encoding of extraction instructions.

Output: extraction-oriented prompt sentence for the generative AI model.

### Step 8:

Server sends the prompt sentence to the generative AI model and obtains structured information.

Server's generative AI interface module calls the generative AI model API, passes the prompt sentence as input text, and receives a generated output describing date, item category, color, place, and other features; server then parses this output into structured fields.

Input: prompt sentence from Step 7.

Data processing: tokenization by the model, multi-layer neural inference, text generation, server-side parsing of the generated text into fields.

Output: structured information (date string, item category text, color text, place text, feature text) stored in the inquiry object.

### Step 9:

Server normalizes temporal and categorical fields.

Server uses a normalization module to convert relative time expressions into absolute calendar dates using server time and time zone, and maps item category and color strings to internal codes according to lookup tables; server stores these normalized values in normalized fields.

Input: structured information from Step 8 and system time metadata.

Data processing: date arithmetic, time zone adjustment, table lookup for category and color.

Output: normalized_fields including date_normalized, item_category_code, color_code, place_code, and feature list.

### Step 10:

Server generates database search conditions based on normalized fields.

Server maps each normalized field to a condition on corresponding database columns, such as equality on item_category_code and color_code and range or equality on found_date, and aggregates these conditions into a query_conditions structure.

Input: normalized_fields from Step 9.

Data processing: rule-based mapping from logical fields to column predicates, combination of predicates with logical operators.

Output: query_conditions object representing constraints for the found-article management database.

### Step 11:

Server constructs an SQL query or equivalent database command.

Server's query construction module converts query_conditions into a concrete SQL statement, including SELECT list, FROM clause specifying the found-article table, WHERE clause with conditions on item_category, color, found_date, and optional place, and optional LIMIT or ORDER BY clauses.

Input: query_conditions from Step 10.

Data processing: string assembly, insertion of parameter values, syntax validation.

Output: executable database query string.

### Step 12:

Server executes the database query and retrieves candidate found-article records.

Server sends the SQL statement to the relational database engine via a database driver, the engine executes index scans or range scans according to the predicates, and server receives a result set containing matching rows.

Input: database query string from Step 11.

Data processing: database execution (index use, filtering), network transfer of result rows to the server.

Output: result set of found-article information associated with the inquiry.

### Step 13:

Server optionally re-ranks or filters the result set using additional logic.

Server may compute similarity scores between the unified inquiry text and stored descriptions, or between visual feature vectors when images are available, and reorder or filter candidate records based on threshold values to reduce noise.

Input: result set from Step 12 and inquiry object (including unified inquiry text and attribute information).

Data processing: similarity computation, scoring, sorting, threshold-based filtering.

Output: refined list of candidate found-article records.

### Step 14:

Server constructs a prompt sentence for response generation.

Server prepares a prompt sentence instructing the generative AI model to generate a user-friendly explanation or summary of the refined list, embedding key fields such as dates, places, colors, and item categories as textual context.

Example prompt sentence:

“Based on the following lost property information, please create an explanatory text in Japanese for users.

Clearly include the date, location, color, and type of item.”

Input: refined candidate records from Step 13.

Data processing: conversion of record fields to descriptive text, insertion into response template.

Output: response-oriented prompt sentence for the generative AI model.

### Step 15:

Server generates a natural language response by using the generative AI model.

Server sends the response-oriented prompt sentence and embedded record descriptions to the generative AI model, receives a generated explanation text, and associates this text with the inquiry as response content.

Input: response-oriented prompt sentence from Step 14.

Data processing: neural text generation by the model, decoding and aggregation into a final response string.

Output: natural language response text summarizing candidate found items.

### Step 16:

Server formats and transmits the response to the terminal.

Server wraps the response text and optionally structured candidate data into a response message (e.g., JSON or HTML), sets an appropriate status code, and sends the message back to the terminal via HTTPS.

Input: response text and candidate records from Steps 13 and 15.

Data processing: serialization into a network message format, header setting, transmission.

Output: response message delivered to the terminal.

### Step 17:

Terminal presents the response to the user.

Terminal parses the response message, displays the generated explanation text and associated item details on the screen, and optionally allows the user to select a candidate record for more details.

Input: response message from Step 16.

Data processing: parsing of structured data, UI rendering on the display device.

Output: visual presentation of search results to the user.

### Step 18:

User reviews the displayed information and identifies the relevant found article.

User inspects the summary text and item details on the terminal display, compares them with the characteristics of the lost article, and decides whether any candidate corresponds to the lost item.

Input: visual information on the terminal screen from Step 17.

Output: human decision and, optionally, subsequent user actions such as contacting the lost-and-found office through the terminal.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

Conventional lost-and-found support systems mainly rely on manually defined keyword matching and simple database queries. In such systems, a server typically receives a user query, extracts a small set of predetermined keywords, and performs direct matching against stored records. This approach suffers from several technical limitations in the field of computer-implemented information retrieval.

First, a conventional server is not able to robustly handle free-form natural language input, speech input, and image input in an integrated manner. Separate subsystems may exist for text search, speech recognition, and image recognition, but these subsystems often operate independently, without a unified representation of search attributes. As a result, the server cannot effectively combine heterogeneous data sources (text, audio, image) into a coherent search key set, which leads to reduced recall and precision in retrieval of relevant found-item records. Second, the conventional server typically does not utilize a generative AI model with structured prompt sentences to convert user inquiries into normalized, machine-readable attribute sets.

Instead, the server depends on rigid pattern matching or rule-based parsers. These techniques do not adapt well to variations in natural language expressions, such as complex time expressions (“the day before yesterday evening”) or vague descriptions (“a small dark-colored wallet near the entrance”). Consequently, the server produces incomplete or inconsistent attribute extraction, which directly degrades search performance in the underlying information storage apparatus. Third, existing systems generally treat time expressions, color descriptions, and object categories as unstructured strings without proper normalization. For example, “yesterday” may not be converted into an explicit calendar date window with respect to a reference time, and “navy blue wallet” may not be mapped to a standardized color category. This lack of normalization makes it technically difficult for the server to generate reliable and optimized search conditions for the storage system, increasing computational overhead (e.g., broad scans or poorly indexed queries) and lowering the accuracy of retrieved candidates.

Fourth, when text-based attributes and image-based attributes conflict (for example, the text indicates “black umbrella” while image analysis yields “dark blue umbrella”), conventional servers typically either ignore one data source or rely on ad-hoc rules. There is no systematic mechanism to assign reliability to each attribute source and to resolve conflicts in a reproducible, computation-efficient way. This causes unstable search behavior and inconsistent ranking of candidates, which is undesirable in computer-implemented retrieval systems that must operate at scale.

Fifth, many existing servers do not exploit generative AI models to generate user-facing natural language responses conditioned on both the user's original inquiry and the ranked set of candidate records. As a result, the server returns only raw database results, placing the burden on the client device or the user to interpret and compare multiple records. This separation leads to redundant data transfer, additional processing on the client side, and suboptimal utilization of server-side computational resources specialized for language generation.

Accordingly, there is a need for an improved computer-implemented system in which a server: (i) integrates natural language text, speech, and image inputs into a unified, structured attribute representation using a generative AI model and dedicated media processing, (ii) normalizes such attributes into standardized formats suitable for efficient and accurate querying of a storage apparatus, (iii) resolves conflicts between different attribute sources based on attribute-wise reliability, and (iv) uses a generative AI model to produce optimized natural language responses reflecting ranked search results. By addressing these issues, the invention aims to improve the technical field of computer-implemented information retrieval, particularly in lost-and-found support scenarios, in terms of accuracy, robustness, computational efficiency, and quality of server-generated responses.

The specific processing by the specific processing unit 290 of the data processing device 12 in Application Example 1 is realized by the following means.

The present invention provides a server comprising a processor configured to receive inquiry information expressed in natural language, audio information, and image information from a user terminal; to generate a first prompt sentence for a generative AI model based on text information obtained by integrating the natural language inquiry information and a speech recognition result derived from the audio information; to transmit the first prompt sentence to a generative information processing apparatus including the generative AI model and to acquire structured keyword information output by the generative AI model; to execute image recognition processing on the image information to obtain visual attribute information including at least object category information and color information; to integrate the structured keyword information and the visual attribute information according to attribute priority rules and complement rules so as to generate integrated keyword information for searching records stored in an information storage apparatus; to convert a date expression included in the integrated keyword information into a concrete calendar date or time range based on a reference time; to generate search conditions for the information storage apparatus based on the integrated keyword information including the converted calendar date or time range, and to execute a search process on the information storage apparatus so as to acquire candidate record information; to evaluate a similarity between each candidate record and the integrated keyword information and to rank the candidate record information based on the evaluated similarity; to generate a second prompt sentence for the generative AI model based on the ranked candidate record information and the natural language inquiry information; to transmit the second prompt sentence to the generative information processing apparatus and to acquire, from the generative AI model, a natural language response message corresponding to the ranked candidate record information; and to transmit the natural language response message and at least part of the candidate record information to the user terminal. This enables the server to technically improve the accuracy and robustness of attribute extraction from heterogeneous user inputs, to normalize and optimize search conditions for efficient querying of the information storage apparatus, to resolve conflicts between text-derived and image-derived attributes based on reliability, and to generate server-side natural language responses that directly reflect ranked search results, thereby enhancing overall computational efficiency and retrieval quality in a computer-implemented lost-and-found support system.

The term “user terminal” refers to an information processing apparatus, such as a portable communication device or a general-purpose computing device, that provides an input/output interface for a user to transmit inquiry information to, and receive response information from, a server over a communication network.

The term “inquiry information” refers to information representing a user's request or question regarding a target object or event, the information being expressed in natural language and optionally including indications of time, place, object type, color, or other descriptive attributes. The term “natural language inquiry information” refers to inquiry information expressed in a human language, such as sentences or phrases input by a user via a text interface or converted from speech, which is not constrained to a predefined command format.

The term “audio information” refers to data representing a sound signal, including at least a user's spoken utterance captured by a microphone of a user terminal and encoded in a digital audio format suitable for speech recognition processing.

The term “image information” refers to data representing a still image or a frame of moving image, including at least a photograph or captured image of an article or environment, encoded in a digital image format suitable for image recognition processing.

The term “processor” refers to one or more hardware circuits configured to execute instructions, including but not limited to a central processing unit, a graphics processing unit, a digital signal processor, or a combination thereof, capable of performing the described operations of the server.

The term “generative AI model” refers to an information processing model, typically implemented as a trained machine learning model such as a neural network, that is configured to generate output data including natural language text or structured data in response to input data and instructions contained in a prompt sentence.

The term “generative information processing apparatus” refers to an information processing system including at least one generative AI model and associated hardware and software, which receives a prompt sentence and related input data and outputs generated text or structured information.

The term “prompt sentence” refers to instruction information supplied to the generative AI model, the instruction information including at least a description of a task to be performed and one or more input texts, and being formatted so as to cause the generative AI model to output desired structured keyword information or natural language responses.

The term “text information” refers to character-based data obtained from natural language inquiry information and/or from a speech recognition result, which is suitable for input to a natural language processing function or a generative AI model.

The term “speech recognition result” refers to a text representation obtained by applying speech recognition processing to audio information so as to convert spoken utterances into corresponding character sequences.

The term “structured keyword information” refers to information output by the generative AI model, the information including one or more attributes such as item category, color, location, and time, arranged in a predetermined data structure format, such as key-value pairs or a record, suitable for use in database searching.

The term “image recognition processing” refers to processing executed on image information by using an image analysis algorithm or model, such as pattern recognition, object detection, or feature extraction, to identify objects, colors, or other visual attributes contained in the image information.

The term “visual attribute information” refers to information indicating attributes derived from image recognition processing, including at least object category information and color information, and optionally including brand, shape, or other visual characteristics.

The term “object category information” refers to attribute information indicating a type or class of a physical object, such as a wallet, bag, umbrella, or other general object group, identified from text information and/or image information.

The term “color information” refers to attribute information indicating a color or color group associated with a physical object, such as blue, black, or red, optionally normalized to a predetermined set of color categories.

The term “attribute priority rules” refers to predefined rules that define relative precedence between different attribute sources or attribute types, such that a server can preferentially adopt one attribute value over another when multiple candidate values exist.

The term “complement rules” refers to predefined rules that define how to supplement or combine attribute values from different sources, such as adding missing attributes from visual attribute information when such attributes are not present in structured keyword information.

The term “integrated keyword information” refers to keyword information generated by combining structured keyword information and visual attribute information according to attribute priority rules and complement rules, the integrated keyword information being used as a unified set of search keys for querying an information storage apparatus.

The term “date expression” refers to a natural language expression indicating a date or time period, such as “today,” “yesterday,” or “last week,” which is included in inquiry information or structured keyword information and is subject to conversion into a concrete calendar representation.

The term “reference time” refers to a time point used as a basis for interpreting a date expression, the time point typically being a current time or a time associated with receipt of inquiry information by the server.

The term “concrete calendar date or time range” refers to an explicit temporal representation, such as a specific calendar date or a start-time and end-time pair, derived from a date expression based on a reference time and suitable for use in time-based searching of records.

The term “information storage apparatus” refers to a storage system including at least one memory device and a control unit, such as a database system, which stores record information including found-item information and supports search processing based on specified conditions.

The term “found-item information” refers to record information representing at least one article that has been found and stored, including attributes such as item category, color, found date, found location, and storage status.

The term “candidate found-item information” refers to one or more found-item records retrieved from the information storage apparatus as search results based on integrated keyword information and time-related search conditions.

The term “similarity evaluation” refers to processing that computes a degree of match between integrated keyword information and each candidate found-item record, based on comparisons of corresponding attributes such as item category, color, time, and location.

The term “ranking processing” refers to processing that orders candidate found-item records according to similarity evaluation results or other scoring criteria, so as to present more relevant records with higher priority.

The term “natural language response message” refers to text information generated for presentation to a user, the text information being expressed in a human language and being created by a generative AI model based on at least inquiry information and candidate record information.

The term “candidate record information” refers to record information acquired from the information storage apparatus as a result of search processing based on integrated keyword information, and may include, but is not limited to, found-item information.

The term “search conditions” refers to conditions used by the server to query the information storage apparatus, the conditions being generated based on standardized attribute formats derived from structured keyword information and possibly including constraints on item category, color, location, date, or time range.

The term “standardized attribute formats” refers to normalized formats for representing attributes, such as canonical codes or controlled vocabulary values, that allow consistent and efficient generation of search conditions and comparison of records in the information storage apparatus.

The term “reliability” refers to a measure or parameter indicating a degree of trustworthiness or confidence assigned to an attribute value obtained from a particular source, such as text analysis or image analysis, which is used for resolving conflicts when generating integrated keyword information.

The term “adoption or coexistence of the attributes” refers to a selection mechanism by which, for each attribute, the server either chooses a single attribute value from multiple candidate values (adoption) or retains multiple attribute values together (coexistence) in integrated keyword information based on reliability or other criteria.

Server implements embodiments of the invention as a combination of hardware resources and software modules that cooperate over a communication network. Server includes at least one central processing unit, at least one main memory, a non-volatile storage device, and a network interface. Server optionally includes a graphics processing unit for accelerating neural network inference. Server executes an operating system such as a general-purpose server operating system and runs application server software that provides application programming interfaces to Terminal.

Terminal includes a processing unit, a memory, a display, an input device such as a touchscreen, a microphone, and a camera. Terminal executes a mobile or desktop operating system and runs a client application that presents a user interface to User. User operates Terminal to input natural language text, to record speech, and to capture or select images related to lost items. Server executes an application program that is divided into modules including a communication module, a speech processing interface module, an image processing interface module, a natural language processing module, a generative AI interface module, an attribute integration module, a time normalization module, a search module, a ranking module, and a response generation module. Each module is implemented as a set of machine-executable instructions stored in the non-volatile storage device and loaded into main memory for execution by the processor. Server uses a speech processing apparatus to convert audio signals received from Terminal into text. Server may implement the speech processing apparatus as a local automatic speech recognition engine or as an external speech recognition service. Server converts the received audio data into a standardized waveform representation, extracts acoustic features such as Mel-frequency cepstral coefficients, and applies an acoustic model such as a deep neural network to estimate phoneme or subword probabilities. Server combines the acoustic model output with a language model, such as an n-gram model or a recurrent neural network language model, to determine a most probable text sequence. This concrete acoustic and language modeling pipeline allows Server to produce a speech recognition result that can be used as text information. By using trained acoustic and language models, Server reduces recognition error rates compared to keyword spotting, thereby improving the accuracy of subsequent attribute extraction. Server uses an image processing apparatus to analyze image data received from Terminal. Server may implement the image processing apparatus as a convolutional neural network or a vision transformer. Server converts the image into a normalized tensor representation, applies convolutional or attention layers to compute feature maps, and uses classification heads to determine object category probabilities and color distributions. Server may further apply region proposal mechanisms or segmentation heads to localize target objects. Server converts the output into visual attribute information including object category information and color information. Because Server applies trained feature extractors and classifiers, Server can recognize object categories and colors even under variations in lighting and viewpoint, which improves robustness compared to simple template matching.

Server uses a generative information processing apparatus including a generative AI model to convert natural language text into structured keyword information and to generate natural language responses. Server implements the generative AI model as a large-scale neural network, such as a transformer-based language model, trained on text corpora including conversational data and instruction-response pairs. The generative AI model includes multiple layers of self-attention and feed-forward networks, and is trained using a sequence-to-sequence or auto-regressive objective. During training, Server or another training system minimizes a loss function, such as cross-entropy between predicted token distributions and ground truth tokens, and uses gradient-based optimization to update model parameters. Server optionally applies regularization techniques such as dropout, and data augmentation techniques such as paraphrasing and noise injection, to improve generalization.

Server provides the generative AI model with a prompt sentence that explicitly defines the extraction or generation task. For attribute extraction, Server constructs a prompt sentence that instructs the model to output a list of attributes like item category, color, date expression, and location in a strict format. For example, Server may use a prompt sentence of the following form: System: You are a service that extracts structured search keywords for a lost-and-found management system.

User inquiry: “Yesterday I forgot my blue wallet.”

Task: Extract item_type, color, date_expression, and location from the user inquiry and provide them in a clearly structured form suitable for database searching. Output only the extracted values in a concise textual form.

Server concatenates this prompt sentence with the user's text and inputs the combined sequence into the generative AI model. The generative AI model processes the tokenized sequence using its attention mechanisms to compute contextual representations and outputs a sequence of tokens representing the structured keyword information. Server then parses the output according to the expected textual structure and converts it into an internal attribute record.

Server similarly constructs a prompt sentence for response generation. For example, Server may use a prompt sentence of the following form:

System: You are a service that explains search results from a lost-and-found management system to a user in simple language.

User inquiry: “Yesterday I forgot my blue wallet.”

Search results: A blue wallet was found near cashier 2 on 2026 Jan. 29 and is stored in the back office with item ID LF-001.

Task: Generate a brief, polite message informing the user of this result. Output only the message text.

Server feeds this prompt sentence and contextual information into the generative AI model, obtains a generated text sequence, and uses that sequence as a natural language response message.

Server internally represents structured keyword information and visual attribute information using explicit data structures. Server stores attributes such as item category, color, location, date expression, and confidence scores in a record with fields for values and associated reliability. Server assigns reliability scores based on the origin of the attribute (e.g., natural language, speech recognition, image recognition) and the confidence values produced by the respective models. Server defines attribute priority rules that specify which source to prefer when multiple candidate values exist. For example, Server may define that, for item category, text-based information from the generative AI model has higher priority when the text explicitly names an object, while image-based information has higher priority when text is ambiguous. Server defines complement rules that specify when to add missing attributes from one source to another without overriding existing values.

Server uses these rules to generate integrated keyword information. Server compares each attribute from the structured keyword information with corresponding attributes from the visual attribute information. Server selects a single value, adopts multiple values, or discards low-reliability values based on the reliability scores and predefined thresholds. This rule-based but model-informed integration is not a simple human replacement; it uses reliability estimators and non-trivial conflict resolution logic to form search keys optimized for database querying. Server implements a time normalization module that converts natural language date expressions into concrete calendar dates or time ranges. Server uses a reference time, such as the server's current time at the moment of inquiry reception, and applies parsing rules to map expressions like “today,” “yesterday,” “the day before yesterday,” and “this morning” into explicit date spans. For more complex expressions, Server may invoke the generative AI model with a dedicated prompt sentence that asks the model to provide an intermediate normalized time expression, and then converts that expression using deterministic rules. By converting free-form time expressions into normalized date ranges, Server reduces the need for broad time windows in database queries, which lowers I/O overhead and improves query performance.

Server implements the search module as an interface to an information storage apparatus, such as a relational database system. Server builds search conditions using standardized attribute formats. Server maps item category values to canonical codes and color values to a controlled color vocabulary. Server constructs structured queries that use equality and range conditions rather than arbitrary keyword matching. Because the attributes are normalized, Server can utilize indexed columns and efficient query planning in the database system. This produces a measurable reduction in query latency and CPU usage compared to raw text search. Server implements the ranking module to compute similarity scores between integrated keyword information and candidate records returned by the storage apparatus. Server may use a scoring function that assigns weights to attribute matches: for example, a match in item category, a match in color, a match in date range, and a partial match in location description. Server may represent attribute values as vector embeddings and compute similarity using measures such as cosine similarity, or may use rule-based scoring. Server then orders the candidate records by score and selects a subset for response generation. This ranking process improves the relevance of the information presented to User, and by limiting the number of records passed to the generative AI model, Server also reduces computational load and network traffic. Terminal displays the natural language response message and structured candidate information to User. Terminal renders the response message and a list of candidate items with details such as category, color, found date, and location. User can read the response and, if necessary, refine the inquiry by providing additional natural language information. Terminal sends the refined inquiry back to Server, which repeats the described processing. This interactive loop allows the system to converge quickly to the correct record while maintaining efficient use of computing resources. This configuration produces technical effects beyond mere automation of human tasks. Server does not simply replace a human operator's manual reading and searching; instead, Server introduces specific computational improvements. By using a generative AI model with designed prompt sentences and integrating its outputs with speech and image recognition results, Server reduces parsing errors and misinterpretations that arise from rule-based or pattern-matching systems. By normalizing attributes and generating optimized search conditions that use structured fields and indexable columns, Server reduces read operations and processing overhead in the information storage apparatus. By ranking candidates server-side and generating concise natural language responses based on ranked results, Server reduces the amount of raw data transmitted to Terminal and decreases the processing load on client devices. These improvements result in faster response times, higher retrieval accuracy, and lower resource consumption.

Server applies training procedures to the generative AI model that further enhance technical performance. Server or an associated training system collects training data pairs consisting of user inquiries and corresponding attribute annotations or response texts. Server encodes the input text and prompt sentences, computes model outputs, and compares the outputs to target sequences using a loss function such as cross-entropy. Server updates model parameters using an optimization algorithm such as stochastic gradient descent with momentum or adaptive moment estimation. Server monitors validation error and applies early stopping or learning rate scheduling to avoid overfitting. Server may perform fine-tuning on domain-specific data related to lost-and-found scenarios, thereby improving the model's ability to recognize relevant attributes like item categories and time expressions. This domain-specific adaptation enables the model to output more precise structured keyword information and more appropriate responses than a generic model.

Server also defines specific non-conventional rules and workflows for combining model outputs. For example, Server may implement a rule that when text analysis and image analysis disagree on color, Server assigns a reliability weight based on confidence scores and the presence of explicit color words in the inquiry. If the text explicitly states “blue” and image analysis has low confidence in “black,” Server adopts “blue” as the primary color. If the text lacks explicit color and image analysis is highly confident in “black,” Server adopts “black.” In cases where neither source dominates, Server records both colors and assigns lower weight to each in the ranking function. This rule-based integration is tailored to the technical problem of attribute inconsistency across modalities and is not a simple transcription of human decision-making.

Alternative embodiments can be implemented. Server may host the generative AI model locally, using a hardware accelerator and an optimized inference runtime, or may access the model as a remote service provided by another computing system. Server may use different neural network architectures for the generative AI model, such as encoder-decoder transformers for sequence-to-sequence tasks, or decoder-only transformers for auto-regressive generation. Server may vary hyperparameters such as the number of layers, attention heads, embedding dimensions, and context length to match performance requirements and computational constraints. Server may use alternative data management systems as the information storage apparatus, including column-oriented databases, key-value stores, or search engines that index structured fields. In each case, Server still generates normalized, structured search conditions to allow efficient access. Server may compress and cache intermediate results such as integrated keyword information and ranked candidate sets, which further improves response times for repeated or similar inquiries.

Terminal may be implemented as a dedicated mobile application, a web browser application, or a kiosk device in a physical facility. In all variants, Terminal interacts with Server using secure network protocols, and presents structured guidance to User based on Server's generated responses. User is not required to manually perform keyword selection or database queries; instead, User provides natural language descriptions, and Server applies the described technical methods to transform, normalize, search, and respond.

Through these embodiments, Server, Terminal, and User cooperate in a system in which the internal computer-implemented mechanisms-namely specific neural network architectures, prompt sentence designs, attribute integration algorithms, time normalization logic, structured query generation, and similarity-based ranking-provide technical improvements in processing speed, retrieval precision, and resource utilization.

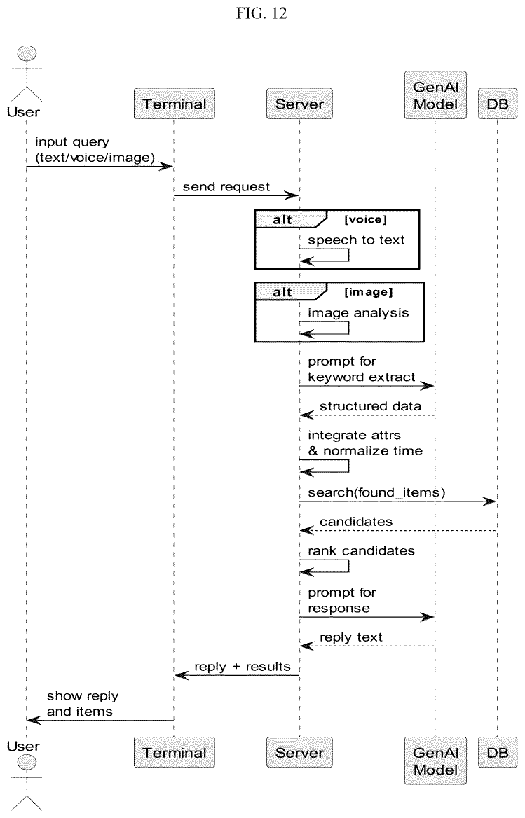

The following describes the processing flow using FIG. 12.

### Step 1:

User operates Terminal to start a lost-and-found application and selects an input mode.

User inputs natural language text describing a lost item, records speech via a microphone, and/or captures or selects an image via a camera or gallery.

Terminal receives the raw text string, raw audio data stream, and/or raw image data as input.

Terminal converts the audio into a standardized digital audio file (for example, linear PCM at a fixed sample rate) and converts the image into a standardized digital image file (for example, JPEG or PNG), and stores temporary identifiers for these media objects.

Terminal constructs a request payload including at least the natural language text (if any), a reference to or encoding of the audio data (if any), a reference to or encoding of the image data (if any), a timestamp, and a device identifier.

Terminal outputs the constructed request payload and transmits it to Server over a network using a secure protocol.

### Step 2:

Server receives the request payload from Terminal as input.

Server parses the payload to extract the natural language text, audio data, image data, timestamp, and device identifier, and validates that at least one of text, audio, or image is present.

Server generates an internal inquiry context object that stores the parsed text, audio, and image fields together with the timestamp and a newly generated request identifier.

Server outputs the inquiry context object for subsequent processing modules.

### Step 3:

Server receives the inquiry context object as input and checks whether audio data is present.

If audio data is present, Server forwards the audio data to a speech processing apparatus, which may be a local automatic speech recognition engine or an external service.

Server provides the audio waveform and recognition configuration parameters (sampling rate, language code, encoding type) and requests transcription.

Server receives a transcription result in the form of a text string as output from the speech processing apparatus.

Server normalizes the transcription by removing leading and trailing spaces, standardizing punctuation, and optionally converting characters to a canonical form.

Server updates the inquiry context object by inserting the transcription as a speech recognition result and, if the original text is absent, by setting the transcription as the main text for further processing.

Server outputs the updated inquiry context object.

### Step 4:

Server receives the updated inquiry context object as input and checks whether image data is present.

If image data is present, Server forwards the image data to an image processing apparatus, which may be implemented as a convolutional neural network or a transformer-based vision model.

Server converts the image into a normalized tensor representation and requests object category estimation and color estimation.

Server receives visual attribute information as output, including object category labels, color labels, and associated confidence scores.

Server transforms the raw model outputs into a structured visual attribute record containing at least one object category attribute and at least one color attribute with confidence values.

Server updates the inquiry context object by adding the structured visual attribute information.

Server outputs the inquiry context object including both text-related and image-related information.

### Step 5:

Server receives the inquiry context object as input and determines the consolidated text to be analyzed by a generative AI model.

Server combines the natural language inquiry text and, if present, the speech recognition result into a single text sequence, using predefined rules to remove duplicates and resolve conflicts.

Server generates a prompt sentence for attribute extraction by embedding the consolidated text into an instruction template addressed to the generative AI model.

Server forms an input sequence by concatenating the system instruction, the user inquiry text, and an explicit task description that requires the extraction of item_type, color, date_expression, and location.

Server outputs the prompt sentence and the consolidated text as input to a generative information processing apparatus.

### Step 6:

Server transmits the prompt sentence and the consolidated text to the generative information processing apparatus as input.

The generative AI model internally tokenizes the text, processes the token sequence using transformer layers with self-attention and feed-forward networks, and computes contextual embeddings for each token position.

The generative AI model generates an output token sequence that encodes structured keyword information reflecting item_type, color, date_expression, and location as textual values.

Server receives the output token sequence and decodes it back into a text string representing structured keyword information as output.

Server parses the structured keyword text into an internal attribute record, mapping textual labels to fields such as item category, color, location phrase, date expression, and associated model confidence if available.

Server outputs the structured keyword record and updates the inquiry context object with this record.

### Step 7:

Server receives the updated inquiry context object, including the structured keyword record and the visual attribute record, as input.

Server applies attribute priority rules and complement rules to integrate both sources into integrated keyword information.

Server computes, for each attribute category (for example, item category and color), a selected value and an associated reliability score based on the origin (text or image) and confidence values.

Server resolves conflicts by adopting the value with higher reliability or, where appropriate, storing multiple alternative values to be used in ranking.

Server generates integrated keyword information as a unified record containing normalized item category, color, location phrase, date expression, and reliability indicators.

Server outputs the integrated keyword information and stores it in the inquiry context object. Step 8:

Server receives the inquiry context object with integrated keyword information as input and identifies any date_expression attribute.

Server uses a reference time, such as the server's current time at inquiry reception, and applies parsing rules to convert the date_expression into explicit calendar dates or time ranges.

Server, for example, converts “today” into a date interval covering the current date, converts “yesterday” into a date interval covering the previous date, and converts “this morning” into a time range within the current date.

Server creates normalized temporal attributes such as search_start_date and search_end date based on the parsed date expression and reference time.

Server updates the integrated keyword information by replacing or augmenting date_expression with the concrete calendar date or time range, and outputs the time-normalized integrated keyword information.

### Step 9:

Server receives the time-normalized integrated keyword information as input and prepares search conditions for an information storage apparatus.

Server maps the item category and color values to standardized attribute formats or codes defined in the storage schema.

Server constructs structured search conditions that specify equality constraints on item category codes, pattern or equality constraints on color codes, and range constraints on found dates between search start_date and search_end_date.

Server sends the constructed search conditions to the information storage apparatus and requests retrieval of found-item records that match these conditions.

Server receives one or more found-item records as candidate found-item information as output, each record including stored attributes such as item category, color, found date, found location, and storage status.

Server outputs the candidate found-item information and associates it with the inquiry context.

### Step 10:

Server receives the candidate found-item information and the integrated keyword information as input and performs similarity evaluation.

Server compares each candidate record's attributes with the integrated keyword attributes, computing attribute-wise match scores based on exact matches, partial matches, and temporal overlaps.

Server aggregates the attribute-wise scores into a total similarity score for each candidate, using predefined weights for item category, color, date, and location.

Server ranks the candidate records in descending order of similarity score and optionally selects a top subset of records for presentation.

Server outputs a ranked list of candidate found-item information, each entry containing at least a record identifier and its similarity score.

### Step 11:

Server receives the ranked candidate found-item information and the original natural language inquiry as input and prepares a prompt sentence for response generation.

Server constructs a response-generation prompt by embedding the user's inquiry and a summary of the most relevant candidate records into an instruction template that asks for a concise explanation.

Server, for example, creates a prompt sentence containing a task description such as “Generate a brief, polite message informing the user of the most relevant found item,” and includes selected record details like item category, color, found location, found date, and item identifier.

Server provides the prompt sentence and contextual information to the generative information processing apparatus as input.

The generative AI model processes this input to generate a natural language response, using its attention mechanisms to condition the output on both the inquiry and the candidate data.

Server receives the generated response text as output, checks it for length constraints or prohibited content, and accepts it as the natural language response message.

Server outputs the natural language response message together with the ranked candidate found-item information.

### Step 12:

Server receives the natural language response message and the ranked candidate found-item information as input for communication to Terminal.

Server encapsulates the response message and a structured representation of the top candidate records into a response payload.

Server transmits this payload to Terminal over the network using a secure protocol.

Terminal receives the response payload from Server as input, parses the natural language response message and the candidate records, and displays them on the screen.

Terminal presents the message as explanatory text and shows the candidate records in a list or card format, allowing User to review item details such as category, color, found date, location, and identifier.

User inspects the displayed information and may determine whether the suggested found item matches the lost item or may provide additional natural language refinements, which Terminal then sends back to Server as new input, causing the described processing to repeat.

It is also possible to incorporate an emotion engine for estimating the user's emotions. That is, the specific processing unit 290 may estimate the user's emotions using an emotion identification model 59, and perform specific processing based on the estimated emotions.

### Example 2

Description follows regarding a flow of the specific processing in an Example 2. The units of the system described below are implemented by the data processing device 12 and the smart device 14. The data processing device 12 is called a “server” and the smart device 14 is called a “terminal”

In conventional lost-article management systems, a server typically performs keyword-based search on a record storage using simple text queries that are manually entered or mechanically derived from user input. When a user provides only unstructured voice information or image information through a terminal, the server often fails to convert such information into an effective search query. In particular, conventional systems do not effectively combine speech processing technology, image processing technology, and natural language generation technology in an integrated query generation pipeline. As a result, the server suffers from low matching accuracy for lost-article identification, especially when the user cannot accurately describe the item in text form.

Furthermore, in known systems, the server generally treats a search as a one-shot operation. When the user supplies additional information in multiple turns, the server does not maintain a coherent session state and does not systematically refine an internal search condition across turns. This leads to inefficient processing, repeated full searches, and an inability to progressively improve search accuracy based on accumulated multi-modal input. In addition, conventional systems often leave the explanation of search results to fixed templates or static rules, which cannot flexibly adapt to the specific combination of candidate records and the nuanced content of the user's inquiry.

From a computer technology perspective, there is therefore a need for an improved server-side processing architecture that: (i) transforms heterogeneous, multi-modal user input (voice and image) into machine-interpretable, structured search conditions; (ii) uses a generative AI model, guided by dynamically constructed prompt sentences, as an internal component of the query generation and result-ranking pipeline; (iii) maintains inquiry session information and incrementally updates search conditions as additional input is received; and (iv) automatically generates user-oriented explanation information that is directly derived from the structured candidate records and the inquiry context. Such an architecture should improve the technical performance of the lost-article identification process, including improved accuracy of record retrieval, more efficient database search through better-specified conditions, and enhanced usability of the system's human-machine interface.

The specific processing by the specific processing unit 290 of the data processing device 12 in Example 2 is realized by the following means.

The present invention provides a server comprising a processor configured to receive, via a terminal, voice information or image information transmitted as an inquiry from a user and store the voice information or the image information as inquiry session information, to perform, for the voice information, a conversion process into text information by using a speech recognition processing apparatus, and to perform, for the image information, a processing of extracting object attribute information and feature quantity information by using an image recognition processing apparatus, to generate, on the basis of the text information, the object attribute information, and the feature quantity information, a prompt sentence to be input to a generative AI model, to obtain structured inquiry information from the generative AI model and generate a search condition for a lost-article management database based on the structured inquiry information, to search, on the basis of the search condition, lost-article information stored in the lost-article management database, to identify a plurality of candidate lost-article information items by an extraction process including a similarity calculation using the feature quantity information, to generate presentation explanation information for the user by using the generative AI model with respect to the candidate lost-article information items, and to transmit the presentation explanation information and the candidate lost-article information items to the terminal so as to output, via the terminal, a lost-article identification result to the user. This enables the server to technically improve the internal processing of multi-modal inquiries by automatically converting heterogeneous user input into structured search conditions through interaction with the generative AI model, to maintain and update inquiry session information for progressive refinement of database search, to perform efficient similarity-based retrieval on stored lost-article information, and to generate adaptive, machine-generated explanation information, thereby enhancing the accuracy, efficiency, and usability of the computer-implemented lost-article management system.

The term “system” refers to an arrangement of one or more computing devices and associated components that cooperate to execute the processing described in the claims. The term “processor” refers to one or more hardware processing units, such as a central processing unit or a graphics processing unit, and any associated control circuitry, configured to execute instructions to perform data processing operations.

The term “terminal” refers to an information processing device operated by a user, such as a portable communication device, a personal computer, or a similar user interface device, that transmits and receives data to and from a server.

The term “user” refers to a human operator who interacts with the system through the terminal by providing inquiries and receiving results.

The term “voice information” refers to digital audio data representing spoken utterances of the user, including data obtained by sampling and encoding an acoustic signal.

The term “image information” refers to digital image data representing visual information, including still images encoded in a predetermined image format.

The term “inquiry” refers to a user request relating to identification or retrieval of a lost article, provided through voice information, image information, text input, or a combination thereof.

The term “inquiry session information” refers to data that associates one or more inquiries from a user with corresponding voice information, image information, timestamps, and intermediate processing results, maintained across multiple interactions.

The term “speech recognition processing apparatus” refers to a hardware and/or software component configured to analyze voice information and convert the voice information into corresponding text information using speech recognition technology.

The term “text information” refers to character string data that represents the semantic content of the user's spoken inquiry obtained by converting the voice information.

The term “image recognition processing apparatus” refers to a hardware and/or software component configured to analyze image information and extract object attribute information and feature quantity information using image analysis technology.

The term “object attribute information” refers to symbolic or categorical data describing properties of an object depicted in the image information, including at least one of an object category, a color, a shape type, a size attribute, or a style attribute.

The term “feature quantity information” refers to numerical data representing characteristics of the image information, including at least one of a feature vector, an embedding, or a descriptor that enables similarity calculation between images.

The term “generative AI model” refers to an artificial intelligence model implemented by hardware and/or software and configured to generate output data, including natural language text or structured data, in response to an input prompt sentence.

The term “prompt sentence” refers to an input text string or sequence of tokens provided to the generative AI model, the prompt sentence specifying at least part of the context, instructions, and data to be processed by the generative AI model.

The term “structured inquiry information” refers to machine-interpretable data, such as a record or a data structure, representing an inquiry in a structured format including fields such as item category, attribute values, location information, time information, and additional notes.

The term “search condition” refers to one or more parameters, constraints, or expressions used by the processor to retrieve records from a database, the search condition being derived from the structured inquiry information.

The term “lost-article management database” refers to a data storage structure that stores lost-article information as records, each record including at least an identifier, attribute data, storage location data, and optionally associated feature quantity information.

The term “lost-article information” refers to data representing a lost article managed by the system, including at least one of a category, an attribute value, a location, a time of discovery, and a storage status.

The term “candidate lost-article information item” refers to a piece of lost-article information retrieved from the lost-article management database that satisfies the search condition and is considered as a potential match to the user's inquiry.

The term “extraction process” refers to a processing sequence in which the processor selects, filters, or ranks records in the lost-article management database on the basis of the search condition and other evaluation criteria.

The term “similarity calculation” refers to a computation that quantifies a degree of similarity between feature quantity information associated with the user's input and feature quantity information stored in the lost-article management database, using a metric such as cosine similarity or Euclidean distance.

The term “presentation explanation information” refers to natural language text or similar data generated for presentation to the user, the presentation explanation information describing at least part of the candidate lost-article information items and guidance for identification or retrieval.

The term “lost-article identification result” refers to output information presented to the user through the terminal, the lost-article identification result including at least the presentation explanation information and one or more candidate lost-article information items.

The term “additional voice information” refers to voice information provided by the user after an initial inquiry within the same inquiry session, the additional voice information being used to refine or update the search condition.

The term “additional image information” refers to image information provided by the user after an initial inquiry within the same inquiry session, the additional image information being used to refine or update the search condition.

The term “response generation information” refers to data output by the generative AI model in response to a prompt sentence that includes candidate lost-article information items and inquiry content, the response generation information being used to evaluate and rank the candidate lost-article information items.

The term “evaluation value” refers to a numerical or ordered value calculated by the processor for each candidate lost-article information item based on the response generation information, the evaluation value indicating an importance or relevance degree.

The term “presentation order” refers to the order in which the candidate lost-article information items are displayed or otherwise presented to the user via the terminal.

In one embodiment, the system includes a server, one or more terminals, and a network connecting the server and the terminals. The server includes at least one processor, a main memory, a nonvolatile storage device, a communication interface, and, optionally, one or more hardware accelerators such as graphics processing units. The terminal includes a processor, a memory, a display device, an input interface including at least a microphone and a camera, and a communication interface. The user operates the terminal to provide inquiries relating to lost articles.

The server executes a program stored in the nonvolatile storage device and loaded into the main memory. The program includes modules for communication control, speech recognition processing, image recognition processing, prompt sentence generation, interaction with a generative AI model, database search, similarity computation, ranking, and response generation. The program is implemented, for example, using a server-side framework such as a web application framework, and runs on an operating system such as a general-purpose server operating system. The speech recognition processing may utilize a speech recognition engine implemented by a neural network model such as a recurrent neural network model or a transformer-based model. The image recognition processing may utilize a convolutional neural network model or a vision transformer model implemented by a machine learning framework such as an open-source tensor computation library. The generative AI model may be a transformer-based language model that outputs natural language or structured text in response to a prompt sentence.

The terminal acquires voice information by using the microphone and the operating system audio application programming interface. The terminal encodes an acoustic signal into digital audio data with a sampling rate, for example 16 kHz, and an encoding format such as pulse code modulation or a compressed audio coding scheme. The terminal acquires image information by using the camera and the operating system camera application programming interface. The terminal encodes a captured image into an image format such as a compressed still image format. The terminal stores the encoded voice information and image information in a memory and transmits the data to the server via the communication interface using a secure communication protocol such as Hypertext Transfer Protocol Secure.

The server receives the voice information and image information and stores corresponding inquiry session information in a storage subsystem. The inquiry session information includes at least a session identifier, a user identifier, timestamps, references to the stored voice information and image information, and intermediate processing results. The server maintains this inquiry session information across multiple communications with the same terminal, so that the server can incrementally refine internal data structures used for lost-article identification.

The server performs speech recognition processing on the voice information by supplying the audio data to the speech recognition processing apparatus. In one embodiment, the server uses a neural network-based acoustic model that accepts a sequence of feature vectors such as Mel-frequency cepstral coefficients. The server computes the feature vectors by applying a short-time Fourier transform, mel-scale filter bank, logarithmic compression, and discrete cosine transform to frames of the audio data. The server supplies these feature vectors to a deep neural network model, for example a transformer model with self-attention layers, which outputs probability distributions over subword units or phonetic units. The server applies a decoding algorithm, such as a beam search combined with a language model, to convert the probability distributions into text information representing a transcription of the user's speech.

The server performs image recognition processing on the image information by supplying decoded pixel data to the image recognition processing apparatus. In one embodiment, the server resizes the image to a standard resolution, normalizes pixel values, and inputs the resulting tensor to a convolutional neural network, such as a residual network with multiple convolutional blocks. The network outputs a feature vector at an intermediate layer and category probabilities at an output layer. The feature vector constitutes the feature quantity information, while the maximum-probability category and associated attributes (such as color, object type, and shape) constitute the object attribute information. The server may further use an object detection network that outputs bounding boxes and class labels to isolate individual objects in complex images.

The server generates a prompt sentence by combining the text information, the object attribute information, and the feature quantity information in a predetermined textual template. For example, the server may generate a prompt sentence such as:

“You are a lost-and-found assistant. The user description is: ‘I lost a blue wallet at the east exit of a station yesterday.’ The image analysis result is: category=wallet, color=blue. Convert this information into a structured search query with fields: category, color, location, time range, and additional notes.”

The server transmits the prompt sentence to the generative AI model. The generative AI model, in one embodiment, is a transformer-based language model with multiple layers of self-attention and feedforward networks. The generative AI model is trained in advance on large-scale text corpora and additionally fine-tuned on domain-specific data that includes examples of lost-article descriptions and corresponding structured representations. During training, the server or another training system minimizes a loss function such as cross-entropy between predicted tokens and ground-truth tokens, and updates network weights using a gradient-based optimization algorithm such as stochastic gradient descent with an adaptive learning rate. The training procedure may include regularization techniques such as dropout, weight decay, and data augmentation of text by paraphrasing.

The server receives structured inquiry information from the output of the generative AI model. The structured inquiry information may appear as text in a machine-interpretable pattern, for example a set of key-value pairs indicating an item category, a color attribute, a location description, a time range, and additional notes. The server parses the structured inquiry information using syntactic rules or pattern-matching algorithms and generates a search condition for a lost-article management database. The search condition may be represented as an internal data structure including filter conditions on specific fields and threshold values for similarity scores.

The server manages the lost-article management database using a database management system such as a relational database system. The lost-article management database stores, for each lost article, at least a unique identifier, category, color, size, storage location, date and time information, and optionally associated feature quantity information obtained from a reference image. The server associates each record with one or more feature vectors stored in a vector index structure such as a tree-based index or an approximate nearest neighbor index.

The server executes a search of the lost-article management database by converting the search condition into, for example, a structured query language statement and one or more similarity search operations. The server filters the records based on exact or partial matches of categorical fields such as category and location. In addition, when feature quantity information derived from the user's image is available, the server computes similarity metrics such as cosine similarity between the user's feature vector and the stored feature vectors. The server may employ an approximate nearest neighbor algorithm to accelerate similarity search, thereby improving processing speed for large-scale databases.

The server identifies a plurality of candidate lost-article information items that satisfy the search condition. The server calculates a composite relevance score for each candidate by combining the similarity metric with weights reflecting the consistency between structured inquiry information and stored fields. For example, the server may assign a higher score when both color and category match and when the similarity in feature vector space exceeds a threshold. The server sorts the candidate items according to the composite relevance score.

The server generates presentation explanation information by preparing another prompt sentence for the generative AI model. The server includes the candidate lost-article information items and the original inquiry content in the prompt sentence. For example, the server may generate: “You are a clerk at a railway lost-and-found office. The user's description is: ‘I lost a blue wallet at a station yesterday.’ The following lost items were retrieved from the database: [summary of items]. Explain to the user, in concise and polite language, which items are the most likely matches and how the user can retrieve the correct item.”

The server inputs this prompt sentence to the generative AI model, obtains response generation information in the form of textual explanation, and calculates an evaluation value for each candidate lost-article information item. In one embodiment, the server instructs the generative AI model to output not only narrative text but also a relative ranking indication or confidence assessment embedded in the text. The server parses this information and translates it into evaluation values. The server then adjusts the presentation order of the candidate items based on these evaluation values, which may differ from the initial composite relevance score, thereby integrating the semantic reasoning capabilities of the generative AI model into the ranking process.

The server transmits the presentation explanation information and the ranked candidate lost-article information items to the terminal. The terminal presents the explanation and the list of candidates on the display device. The user can confirm whether a specific candidate corresponds to the user's lost article. If the user does not find a suitable candidate, the user may provide additional voice information or image information to refine the inquiry.

The server receives additional voice information or image information and associates it with the existing inquiry session information. The server repeats the speech recognition and image recognition processes, generates updated text information, object attribute information, and feature quantity information, and produces an updated prompt sentence to the generative AI model. The server receives updated structured inquiry information, regenerates the search condition, and re-executes the database search. Because the server maintains a session-level representation of the inquiry, including previously extracted features and refined conditions, the server can converge on more accurate results in fewer iterations than a conventional one-shot keyword search system. This contributes to reduction of communication load and computational resources by avoiding redundant searches over the entire database.

In another embodiment, the server uses a different neural network architecture for image recognition, such as a vision transformer that divides an image into patches and applies self-attention mechanisms across patches. The server processes sequences of patch embeddings to obtain feature quantity information. The vision transformer may be trained using a classification loss, and optionally a contrastive loss to improve the quality of the feature space for similarity comparison. In yet another embodiment, the speech recognition processing uses a connectionist temporal classification loss to align input acoustic frames with output symbols. In yet another embodiment, the generative AI model is deployed on the same physical machine as the lost-article management database, and the server executes inference using a hardware accelerator. The server manages a cache of recent prompt sentences and partial outputs to reduce inference latency for repeated patterns of inquiries. By restructuring the inquiry into a structured form and pre-filtering the database based on structured fields before performing high-cost similarity computation, the server reduces the overall computational complexity of the retrieval process.

From a technical viewpoint, the described combination of speech recognition processing, image recognition processing, prompt sentence generation, and integration with a generative AI model improves the internal functioning of the computer system. The server does not merely replace human clerks with automated scripts; instead, the server introduces specific data structures for inquiry session information, structured inquiry information, search conditions, and feature quantity information, and uses neural network-based models to transform heterogeneous input into optimized search parameters. This transformation enables more precise and efficient database operations than simple keyword matching, leading to higher retrieval accuracy and lower error rates in identifying lost articles. The use of feature vectors and similarity calculation allows the system to handle noisy or incomplete user input in ways that traditional exact-match database queries cannot.

Furthermore, the server's iterative refinement mechanism, in which additional multi-modal input is integrated into an evolving search condition, represents a non-conventional processing sequence that adapts to the state of the session. The system thereby improves processing speed and reduces unnecessary database scans by focusing on progressively narrower subsets of data as the inquiry is refined. The generative AI model is utilized not only for human-readable responses but also as an internal reasoning component that helps to rank and interpret candidate records based on complex semantic relations that are difficult to encode using fixed rules.

In an alternative embodiment, the terminal performs part of the pre-processing, such as on-device noise reduction for voice information or resolution adjustment for image information, before transmitting the data to the server. This reduces network bandwidth usage and improves end-to-end latency. In another alternative embodiment, the server stores model parameters and feature indices in separate storage clusters and distributes computation across nodes, using load balancing to handle large volumes of inquiries.

The described embodiments thus provide concrete configurations and operations that allow the server, the terminal, and the user to cooperate in a technically improved lost-article management system. By specifying particular neural network architectures, feature extraction techniques, data structures, and algorithmic flows, the system achieves technical effects including improved search accuracy, reduced processing time, improved utilization of database resources, and enhanced robustness to incomplete or ambiguous user input.

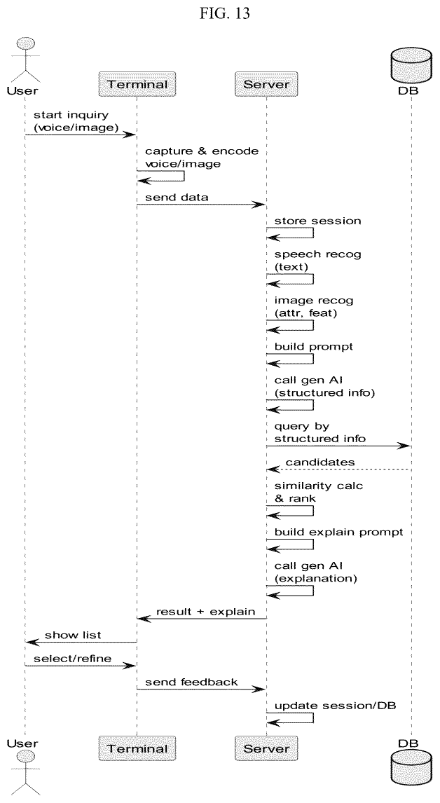

The following describes the processing flow using FIG. 13.

### Step 1:

The user activates an application on the terminal and initiates a lost-article inquiry. The user provides input by speaking into a microphone or capturing an image with a camera. The input of this step is an acoustic signal and/or an optical signal corresponding to the user's description of a lost article. The output of this step is raw voice information and/or image information temporarily stored in a memory of the terminal.

### Step 2:

The terminal converts the acoustic signal into digitized voice information and the optical signal into digitized image information. The terminal uses an operating system audio interface to sample the acoustic signal at a predetermined sampling rate and to encode the samples into an audio file, and uses a camera interface to acquire a frame and encode it into an image file. The input of this step is the raw acoustic and optical signals from the user, and the output of this step is encoded voice information and encoded image information stored as files or data buffers on the terminal.

### Step 3:

The terminal generates a transmission request and sends the encoded voice information and/or encoded image information to the server via a network. The terminal encapsulates the data in a request message including identifiers and timestamps, and uses a secure communication protocol to transmit the message. The input of this step is the encoded voice information and encoded image information together with metadata, and the output of this step is a network message delivered to the server containing the user's inquiry data.

### Step 4:

The server receives the network message and stores inquiry session information in a storage subsystem. The server parses the message, extracts the voice information and image information, assigns or retrieves a session identifier, and records associations between the session identifier, the user identifier, the timestamps, and references to the stored data objects. The input of this step is the received network message containing encoded media and metadata, and the output of this step is inquiry session information persisted in a database or other storage structure.

### Step 5:

The server performs speech recognition processing on the voice information to generate text information. The server reads the encoded audio file, applies digital signal processing to compute feature vectors such as Mel-frequency cepstral coefficients, and feeds the feature vectors into a neural network-based acoustic model and language model to decode the most likely sequence of text tokens. The input of this step is the encoded voice information linked to the inquiry session, and the output of this step is text information representing a transcription of the user's spoken description.

### Step 6:

The server performs image recognition processing on the image information to generate object attribute information and feature quantity information. The server decodes the image, resizes and normalizes pixel values, and inputs the resulting tensor into an image recognition model such as a convolutional neural network. The model computes an internal feature vector at an intermediate layer and category probabilities at an output layer. The input of this step is the encoded image information linked to the inquiry session, and the output of this step is object attribute information such as item category and color, and feature quantity information in the form of one or more numerical feature vectors.

### Step 7:

The server generates a prompt sentence for a generative AI model on the basis of the text information, the object attribute information, and the feature quantity information. The server concatenates normalized text information, symbolic attributes, and a textual abstraction of the feature quantity information into a natural language instruction that includes a request to output a structured representation of the inquiry. The input of this step is the set of recognition results from the speech and image processing, and the output of this step is a prompt sentence formatted as a textual string.

### Step 8:

The server transmits the prompt sentence to the generative AI model and obtains structured inquiry information. The server submits the prompt sentence as input tokens to the generative AI model, causes the model to execute a forward pass through multiple attention and feedforward layers, and receives generated output tokens that encode a structured description of the lost article. The input of this step is the prompt sentence created in Step 7, and the output of this step is structured inquiry information including at least an item category, attribute fields, location information, and a time range expressed in a machine-interpretable form.

### Step 9:

The server generates a search condition for a lost-article management database using the structured inquiry information. The server maps fields of the structured inquiry information to database fields, applies normalization rules to locations and times, and constructs a data structure representing filter predicates and thresholds for similarity computations. The input of this step is the structured inquiry information returned by the generative AI model, and the output of this step is a search condition usable to drive both database queries and similarity search operations.

### Step 10:

The server executes a database search for lost-article information based on the search condition. The server translates the search condition into one or more database queries, sends the queries to a database engine, and retrieves records whose categorical fields match the condition within predetermined tolerances. The input of this step is the search condition generated in Step 9, and the output of this step is a set of lost-article information records that satisfy the filter portion of the search condition.

### Step 11:

The server computes similarity scores between feature quantity information derived from the user's image and feature quantity information stored for candidate records. The server loads stored feature vectors corresponding to candidate lost-article records, performs numerical operations such as dot products and norm calculations to obtain cosine similarity or distance values, and assigns a similarity score to each record. The input of this step is the user's feature quantity information and the stored feature vectors for candidate records, and the output of this step is a list of candidate lost-article information items each associated with a similarity score.

### Step 12:

The server ranks the candidate lost-article information items based on a composite relevance value. The server combines similarity scores with weights derived from matches in category, color, location, and time, and calculates a composite score for each candidate using arithmetic operations such as weighted summation and normalization. The input of this step is the candidate items with similarity scores and field-match indicators, and the output of this step is an ordered list of candidate lost-article information items sorted by composite relevance.

### Step 13:

The server generates a second prompt sentence for the generative AI model that includes the ranked candidate items and the original inquiry content. The server converts key attributes of the candidate items and the user's description into textual summaries and inserts them into a template that instructs the generative AI model to produce an explanation and, optionally, ranking guidance. The input of this step is the ordered candidate list and the inquiry session information, and the output of this step is a second prompt sentence formatted for explanation generation.

### Step 14:

The server inputs the second prompt sentence to the generative AI model and obtains response generation information. The server feeds the prompt text to the model, causes the model to generate an output sequence that contains natural language explanation and potentially indicators of confidence or relative importance for each candidate, and collects this output in a buffer. The input of this step is the second prompt sentence generated in Step 13, and the output of this step is response generation information consisting of explanation text and optional ranking cues.

### Step 15:

The server derives presentation explanation information and updated evaluation values from the response generation information. The server parses the generated text using pattern-matching rules or lightweight natural language analysis, extracts any explicit or implicit ranking or confidence clues, and, if present, converts them into updated numerical evaluation values. The input of this step is the response generation information from the generative AI model, and the output of this step is presentation explanation information for the user and, optionally, refined evaluation values for the candidate list.

### Step 16:

The server finalizes the presentation order of candidate lost-article information items using the evaluation values. The server compares the composite relevance scores with any updated evaluation values, applies a predetermined aggregation rule or tie-breaking rule, and adjusts the ordering of candidate items accordingly. The input of this step is the candidate list with composite scores and optional updated evaluation values, and the output of this step is a finalized, ordered list of candidate lost-article information items ready for presentation.

### Step 17:

The server transmits the presentation explanation information and the finalized candidate list to the terminal. The server packages the explanation text and structured candidate data into a response message, encodes the data in a transfer format, and sends the message through the communication interface. The input of this step is the presentation explanation information and the ordered candidate list, and the output of this step is a network response delivered to the terminal.

### Step 18:

The terminal receives the response message and renders the lost-article identification result to the user. The terminal parses the received data, populates user interface components with the explanation text and item attributes, and displays selectable entries for each candidate. The input of this step is the response message from the server containing explanation and candidate data, and the output of this step is a graphical presentation on the display that allows the user to review and select possible matches.

### Step 19:

The user evaluates the displayed candidate lost-article information items and optionally provides additional input. The user reads the explanation, inspects any displayed images or attributes, and either selects a candidate as a match or initiates another inquiry by supplying more detailed voice information or additional image information. The input of this step is the presented identification result on the terminal, and the output of this step is user feedback in the form of a selection command or supplemental media input.

### Step 20:

The server receives user feedback indicating a selection or additional input and updates the inquiry session information. When the user selects a candidate, the server records the selection and may update the status of the corresponding record in the lost-article management database. When the user supplies additional voice information or image information, the server appends new references and recognition results to the existing inquiry session data. The input of this step is the user feedback transmitted by the terminal, and the output of this step is an updated session state that either completes the identification or triggers a repetition of earlier processing steps with refined input.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

Conventional lost-and-found management systems and conversational assistance systems suffer from several technical limitations when processing multimodal user inquiries that include text, audio, and images. Typical systems treat natural-language understanding, speech recognition, image analysis, database search, and response generation as isolated components with static rules. As a result, these systems often fail to generate coherent internal representations of a user's inquiry, cannot effectively combine textual and visual features to search structured storage, and are unable to adapt system behavior based on the user's emotional state. This leads to inefficient use of computational resources, sub-optimal search strategies over stored data, and increased latency and error rates in identifying relevant lost-article records.

In particular, existing systems generally lack a mechanism to construct and maintain a unified query context across modalities, and to use that context to generate prompt sentences that drive a generative AI model in a deterministic, system-controlled way. Without such prompt-driven orchestration, the generative AI model is either not used at all, or is used in an ad-hoc manner that does not reliably yield structured search parameters or emotionally adapted responses. Furthermore, search over storage containing lost-article information is typically limited to text-only queries, without leveraging feature vectors derived from image analysis for similarity search. This prevents efficient narrowing of candidate items when multiple visually similar articles exist.

Another technical problem arises from the absence of integrated emotion analysis that directly influences core system behavior. Conventional systems, even when they detect user sentiment, do not systematically incorporate the detected emotional state into search priority control, search range adjustment, or prompt design for response generation. Consequently, these systems cannot dynamically allocate computational and data-access resources based on urgency or user distress, nor can they tailor the generative AI model's outputs to match the user's emotional needs while maintaining consistency with the underlying data.

Accordingly, there is a need for a computer-implemented system that (i) maintains a persistent, multimodal query context, (ii) generates structured prompt sentences to control a generative AI model for extraction of attribute information and search parameters, (iii) combines text-based search and feature-vector-based similarity search over storage containing lost-article information, and (iv) estimates a user's emotional state and uses that state both to control search behavior and to specify response style in prompts, thereby improving computational efficiency, search accuracy, and the technical quality of generated responses.

The specific processing by the specific processing unit 290 of the data processing device 12 in Application Example 2 is realized by the following means.

The present invention provides a server comprising a processor configured to receive, from a terminal operated by a user, text data, audio data, and image data, to store a query context including an inquiry content composed of the text data and the audio data, and to maintain the query context across processing stages; to generate a first prompt sentence for a generative AI model, the first prompt sentence being constructed based on the query context and the image data, and to cause the generative AI model, according to the first prompt sentence, to extract attribute information of a lost article and search parameters from the inquiry content and the image data; to perform speech recognition processing on the audio data to convert the audio data into converted text data and to update the query context by integrating the converted text data with the text data as speech processing; to perform image analysis processing on the image data to extract feature information including object information, color information, and a feature vector as image processing; to search storage containing lost-article information based on the search parameters extracted by the generative AI model and the feature information, and to identify candidate lost articles by combining a text-based search and a similarity search based on the feature vector; to estimate an emotional state of the user based on at least one of the query context, the audio data, and the text data; to generate a second prompt sentence for response generation for the generative AI model using a response-generation context including the emotional state and a search result of the candidate lost articles, and to cause the generative AI model, according to the second prompt sentence, to generate a natural language response to be presented to the user; to dynamically control at least one of a search priority and a search range for the candidate lost articles according to the estimated emotional state and the search parameters; and to transmit the natural language response and information relating to the candidate lost articles to the terminal for provision to the user. This enables the server to improve computer-implemented processing of multimodal lost-item inquiries by unifying text, audio, and image information into a persistent query context, by programmatically controlling a generative AI model through structured prompt sentences to obtain reliable search parameters and emotionally adapted responses, by performing combined text and feature-vector similarity search over storage to efficiently narrow candidate items, and by dynamically adjusting search behavior and response style in accordance with the user's emotional state, thereby enhancing search accuracy, resource utilization, and overall system responsiveness.

The term “processor” refers to a hardware or virtual computation unit, such as a central processing unit or a processing core in an electronic apparatus, configured to execute instructions and perform the operations described in the claims.

The term “terminal” refers to an information processing apparatus operated by a user, such as a mobile communication device, a portable computing device, or a fixed interactive device, capable of capturing, transmitting, and receiving data including text data, audio data, and image data.

The term “user” refers to any person or entity that operates the terminal to submit an inquiry, particularly an inquiry relating to a lost article, and to receive a response from the system.

The term “text data” refers to character-based digital information representing natural language input, including data obtained from manual input via a user interface or from conversion of audio data by speech recognition processing.

The term “audio data” refers to digital signal data representing sound, including human speech captured by a sound-capturing device associated with the terminal.

The term “image data” refers to digital data representing a still or moving visual scene, including an image of an article captured by an image-capturing device associated with the terminal.

The term “query context” refers to a structured internal data representation maintained by the processor that aggregates and preserves information related to a user inquiry, including at least the inquiry content, derived text data, audio-derived text data, image-derived information, and associated metadata.

The term “inquiry content” refers to the semantic content of a user's request regarding a lost article, expressed in natural language and represented in the system as text data, including at least text manually input by the user and text obtained from audio data.

The term “generative AI model” refers to a machine learning model configured to generate output data, such as natural language text, based on input data and a prompt sentence, the model including a natural language processing model trained on large amounts of language data.

The term “prompt sentence” refers to textual instruction data supplied to the generative AI model, the instruction data specifying at least a task, input context, and desired output properties, and thereby controlling the behavior and output of the generative AI model.

The term “first prompt sentence” refers to a prompt sentence generated by the processor and provided to the generative AI model for the purpose of extracting attribute information and search parameters from the inquiry content and the image data.

The term “second prompt sentence” refers to a prompt sentence generated by the processor and provided to the generative AI model for the purpose of generating a natural language response to be presented to the user, based on a response-generation context.

The term “attribute information” refers to structured data describing properties of a lost article, including at least an article category, a color, a shape, a size, a time-related attribute, or other distinguishing features that can be used for searching stored information.

The term “search parameters” refers to structured control data derived from the inquiry content and image data, including attribute information, time ranges, location constraints, and priority indicators, which are used by the processor to form search queries against storage.

The term “speech recognition processing” refers to a computational process that analyzes audio data representing speech and converts the audio data into corresponding text data using acoustic and language models.

The term “converted text data” refers to text data obtained by applying speech recognition processing to audio data, which is integrated with other text data in the query context.

The term “image analysis processing” refers to a computational process that analyzes image data to detect and extract feature information including object information, color information, and feature vectors.

The term “feature information” refers to structured data extracted from image data, including at least object information, color information, and a feature vector, which collectively characterize visual aspects of an article depicted in the image data.

The term “object information” refers to data indicating one or more object categories or labels corresponding to items detected within the image data, such as an umbrella, a bag, or a wallet.

The term “color information” refers to data representing dominant or characteristic colors associated with an article or a region within the image data.

The term “feature vector” refers to a numerical vector representation of visual features derived from the image data, suitable for use in similarity calculations and vector-based search over stored visual representations.

The term “storage” refers to one or more data storage resources, such as databases, file systems, or other non-transitory storage media, configured to store lost-article information and related records.

The term “lost-article information” refers to records stored in storage that describe articles that have been reported, found, or managed as lost items, including at least attribute information, acquisition time, storage location, and management identifiers.

The term “candidate lost articles” refers to one or more articles identified from the lost-article information as potential matches to a user's inquiry, based on text-based search and similarity search using feature vectors.

The term “text-based search” refers to a search procedure in which search parameters expressed as textual or symbolic conditions are applied to lost-article information using operations such as keyword matching, field filtering, and logical comparison.

The term “similarity search based on the feature vector” refers to a search procedure in which feature vectors derived from image data are compared with feature vectors stored in association with lost-article information, using a similarity metric to identify visually similar articles.

The term “emotional state” refers to a classification or quantitative representation of a user's affective condition, such as anxiety, sadness, urgency, or neutrality, estimated from at least one of the query context, the audio data, and the text data.

The term “response-generation context” refers to aggregated information used for generating a natural language response, including at least the emotional state of the user, the search result of the candidate lost articles, and optionally other elements of the query context.

The term “natural language response” refers to text data generated by the generative AI model in a human-readable language, intended to be presented to the user as an answer or guidance regarding the user's inquiry.

The term “search priority” refers to a control parameter used by the processor to determine an order, speed, or resource allocation for executing searches over storage, and which can be increased or decreased in accordance with the emotional state and search parameters.

The term “search range” refers to a scope of data or conditions over which a search is conducted in the storage, including at least a temporal range, a spatial range, a category range, or a subset of records, which can be expanded or narrowed based on the emotional state and search parameters.

The term “writing style” refers to linguistic characteristics of the natural language response, such as formality, directness, and phrasing patterns, which can be specified in the prompt sentence to influence the generative AI model's output.

The term “politeness level” refers to a degree of courteousness or formality in the natural language response, which is controlled through instruction information included in the prompt sentence.

The term “degree of encouragement” refers to a qualitative or quantitative level of supportive or reassuring expressions included in the natural language response, which is specified for the generative AI model in accordance with the emotional state of the user.

The term “past inquiry history” refers to stored data representing previous inquiries made by the same user or within the same session, including prior query contexts and responses.

The term “search result history” refers to stored data representing past search results and identified candidate lost articles associated with previous inquiries, including their attributes and outcomes.

The term “continuous dialogue context” refers to an aggregated representation of multiple related inquiries, responses, and search results over time, used to enable the generative AI model to generate responses that are coherent across multiple turns of interaction.

In one embodiment, a server, a terminal, and a user cooperate to implement the claimed system. The server includes at least one processor, a main memory, a non-transitory storage device, and a network interface. The terminal includes at least one processor, a memory, a display unit, an input unit such as a touch panel or keyboard, a microphone, a camera, and a wireless or wired communication interface. The user operates the terminal in a physical environment such as a retail facility or service counter to inquire about lost articles or to register found articles.

The server executes a server-side program stored in the storage device. The server-side program includes modules that realize a multimodal query context manager, a speech recognition interface, an image analysis interface, a generative AI interface, an emotion estimation module, a search controller, and a response generator. The terminal executes a client-side program that realizes a graphical user interface, audio capture, image capture, local buffering of user data, and secure communication with the server via a communication protocol such as HTTPS.

The server uses a data storage structure that includes at least (i) a lost-article information database, (ii) a feature-vector store for image-derived features, and (iii) a session store for query contexts and dialogue histories. In one embodiment, the lost-article information database is implemented using a relational database management system, and stores, for each article, a record including an article identifier, an article category, an article color, a free-text description, a found date and time, a storage location, and a feature vector reference. The feature-vector store is implemented as a separate table or as a specialized approximate nearest-neighbor index (for example, a product-quantization-based index) storing high-dimensional feature vectors derived from images and associated article identifiers. The session store is implemented as a key-value store in which a session identifier is associated with a structured query context object that aggregates text data, audio-derived text data, image-derived feature information, emotion information, and search results.

The server uses a generative AI model as a neural network configured for conditional text generation. In one embodiment, the generative AI model is realized as a transformer-based architecture having multiple self-attention layers, feed-forward layers, and positional encoding. The server stores, in the storage device, trained model parameters that were obtained by pre-training the neural network on a large corpus of natural language text using an auto-regressive objective, and optionally by fine-tuning the network on domain-specific conversational data relating to lost-article scenarios. During training, the server or a training system minimizes a cross-entropy loss function between predicted tokens and ground-truth tokens using gradient-based optimization, such as stochastic gradient descent or an adaptive variant, and updates the model weights by backpropagation. In a fine-tuning phase, the server may perform supervised fine-tuning where model outputs are matched to curated responses, and may further perform reinforcement learning from human feedback in which a reward model promotes outputs that are factually consistent and emotionally appropriate. The server stores the resulting trained generative AI model in a model repository and loads it into memory for inference.

The server uses an external or internal speech recognition engine to convert audio data into text data. In one embodiment, the speech recognition engine is realized as a deep neural network that maps sequences of audio features (for example, Mel-frequency cepstral coefficients or log-Mel filterbank features) to character or sub-word sequences. The server sends audio frames obtained from the terminal to the speech recognition engine, which produces time-aligned token sequences. The server aggregates the tokens into a text string and normalizes punctuation, casing, and language-specific markers. The server then stores the converted text in the query context. Because the speech recognition engine operates on encoded audio features and uses language models optimized for conversational queries, the conversion process reduces recognition errors that might otherwise propagate into the subsequent search steps, thereby improving overall accuracy of candidate article identification.

The server uses an image analysis engine to extract feature information from image data captured by the terminal. In one embodiment, the image analysis engine includes a convolutional neural network backbone such as a residual network or a vision transformer configured to accept an image tensor and to output a feature map. The server obtains, from intermediate or final network layers, a dense feature representation that is pooled into a fixed-length feature vector. The server also applies classification heads and segmentation heads to generate object information labels (for example, umbrella, bag, wallet) and color information labels (for example, red, blue, black), and may detect brand logos or patterns. The server normalizes and quantizes the resulting feature vector, stores it in the feature-vector store, and associates it with the relevant query context or lost-article record. By using a high-dimensional feature vector rather than only discrete labels, the server enables efficient similarity search in continuous feature space, which reduces ambiguity when multiple articles are textually similar but visually different.

The server constructs and maintains a query context object as a structured record that includes at least the following fields: a user identifier or session identifier, manually input text data, audio-derived text data, image-derived labels, image feature vectors, estimated emotional state, search parameters, candidate article identifiers, and dialogue history. The server updates this query context whenever new user input arrives or whenever new analysis results are available. The server stores the query context in the session store, so that multiple rounds of interaction form a continuous dialogue. This data structure and its update rules provide a specific way of unifying multimodal inputs inside the computer, rather than handling each input stream independently, and thereby improve coherency and contextual consistency of generated responses.

The server uses the query context to generate prompt sentences for the generative AI model. In one embodiment, the server assembles a first prompt sentence for attribute and parameter extraction. The server can, for example, formulate the first prompt sentence as:

“Extract structured attributes from the following lost-item query.

Query text: ‘I forgot my red umbrella yesterday.’

Image labels: {umbrella, red, folding}.

Return a JSON-like description with fields: item_type, color, date_reference, urgency_level.” The server feeds this prompt sentence, together with the query text and image-derived labels, as input tokens to the generative AI model. The generative AI model outputs a sequence of tokens that, when decoded, represents structured attribute information and search parameters. The server parses the output into a machine-readable structure and maps expressions such as “yesterday” into an absolute date based on the system clock. By using the generative AI model in this constrained, prompt-driven manner, the server obtains search parameters that capture implied information (such as urgency) and temporal references that are difficult to extract with traditional keyword-based parsers. This results in fewer search misses and reduces the need for manual rule engineering.

The server estimates an emotional state of the user based on at least one of the query context, audio prosody, and text semantics. In one embodiment, the server uses a separate emotion estimation model implemented as a neural network classifier that takes as input an embedding of the user's text and, optionally, prosodic features such as pitch, energy, and speaking rate extracted from the audio signal. The server encodes the text using a transformer-based encoder to obtain a sentence embedding, concatenates it with the prosodic feature vector, and feeds the concatenated vector into a fully connected network that outputs probability scores for emotion classes such as sadness, anxiety, anger, and neutrality. The server selects the emotion class with the highest probability as the primary emotional state and stores the result in the query context. This model is trained using supervised learning on labeled emotional speech and text datasets, where a cross-entropy loss function is minimized. The training process adjusts the model's weights to optimize discrimination between emotional categories. As a result, the server can detect subtle emotional cues that are not obvious from keywords alone, enabling more nuanced control of downstream processing.

The server applies the extracted search parameters and the image feature vector to execute a combined search over the lost-article information database and the feature-vector store. In one embodiment, the server translates the search parameters into a structured query that filters by article category, color, date range, and location in the relational database. The server retrieves a candidate set of records that satisfy these constraints. The server then retrieves corresponding feature vectors from the feature-vector store and computes similarity scores between these stored vectors and the query image feature vector, using a similarity metric such as cosine similarity or Euclidean distance. The server optionally uses a vector index structure, such as a hierarchical navigable small world graph or a product-quantization index, to accelerate nearest-neighbor search. The server combines the similarity scores with text-based match scores derived from keyword overlap or semantic similarity of descriptions to compute an overall relevance score for each record. The server sorts candidates by the relevance score and retains the top N candidates as candidate lost articles. This combined search process reduces both false positives and false negatives compared with purely text-based search, and improves computational efficiency through approximate nearest-neighbor indexing.

The server uses the emotional state and the search parameters to dynamically control search priority and search range. For example, when the emotional state corresponds to high urgency or high anxiety, the server can allocate more processing threads to the search controller, reduce allowable latency thresholds, expand the temporal search range to include neighboring days, and relax certain filters such as location constraints. Conversely, when the emotional state is calm and the inquiry is not urgent, the server can apply stricter filters and lower priority to preserve resources for high-priority tasks. This dynamic control is implemented by the search controller using explicit policies encoded as rules or learned decision models, and it directly affects how the database queries and vector searches are scheduled and parameterized. As a result, the system not only changes messaging tone but also changes underlying computational behavior, thereby improving resource utilization and responsiveness in a technically meaningful way.

The server constructs a second prompt sentence for the generative AI model to generate a natural language response. The server uses the query context, including the emotional state and the candidate lost articles, to assemble this prompt. In one embodiment, the server formulates the second prompt sentence as:

“You are a support assistant in a physical store.

User message: ‘I forgot my red umbrella yesterday.’

Detected emotion: sadness (0.86). Urgency: medium.

Database result: one red umbrella found yesterday at Entrance A, article_id 12345, currently stored at the information desk, pickup requires identification and a brief description.

Task: Generate a short, polite, and reassuring response in English.
1) Acknowledge that the user lost a red umbrella.
2) Clearly tell the user where to go and what to bring.
3) Use a gentle and encouraging tone.”

The server injects into the prompt explicit instruction information specifying writing style, politeness level, and degree of encouragement. Because this instruction information is encoded in the tokens fed into the generative AI model, the model's internal attention mechanisms condition its output distribution on these stylistic constraints. The server receives the generated text, validates the content, and, if necessary, truncates or regenerates the response by adjusting the prompt. By iteratively refining prompts and reusing the same trained generative AI model, the server can realize multiple response styles without storing separate rule-based templates, thereby reducing code complexity and enabling flexible adaptation to different emotional states. The terminal presents the response and article information to the user. The terminal receives, from the server, a response message that includes the natural language response text, a list of candidate article identifiers, and associated metadata such as storage locations and pickup instructions. The terminal displays the response text on the screen and may highlight key information such as the nearest location map. The terminal may also synthesize speech from the response text using a text-to-speech engine and play it through a speaker. The user can then physically go to the indicated location, present identification, and recover the lost article. The terminal may further allow the user to provide follow-up feedback, which the server stores in the query context and uses in subsequent prompt sentences to maintain a continuous dialogue. In another embodiment, the server supports a variant where the user provides only text data. In such a case, the server creates the query context using the text input, omits image analysis, and still uses the generative AI model and the emotion estimation model to extract attribute information and emotional state. The server then performs text-based search only. Even in this simplified case, the use of a learned generative AI model for structured parameter extraction improves robustness to ambiguous language and reduces the number of hard-coded parsing rules, which constitutes an improvement of the computer's ability to process natural-language queries. In yet another embodiment, the server supports batch processing of found-article registration. A staff member uses the terminal to capture images of multiple found articles. The terminal sends the images and short voice descriptions to the server. The server applies the same image analysis and speech recognition processes, uses the generative AI model with appropriate prompt sentences to automatically generate article categories, colors, and concise descriptions, and populates the lost-article information database with minimal manual input. The server thus reduces data entry errors and increases consistency of stored records, which improves subsequent search performance for all users.

The described architecture and processing flow provide technical improvements beyond mere automation of human decision making. The server integrates specialized neural network models (speech recognition, image analysis, generative text, and emotion estimation) with specific data structures (query context object, feature-vector store) and algorithmic procedures (prompt-driven parameter extraction, combined text and vector similarity search, emotion-controlled search policy) to enhance the computer's ability to process multimodal inputs. The use of high-dimensional feature vectors and approximate nearest-neighbor search reduces search time over large lost-article datasets while preserving high recall, thereby improving processing speed and scalability. The use of a persistent query context and emotion-conditioned prompts reduces misinterpretation and re-analysis across turns, lowering redundant computation and communication. The dynamic adjustment of search priority and range based on emotional state leads to better allocation of processing resources and reduced average latency for urgent cases. These effects arise from specific internal processing and control of computing components and are not achievable by simply instructing a human operator to “try harder” or “be more empathetic.”

Alternative configurations are also possible. The server may host the generative AI model locally or may communicate with a remote inference service over a low-latency network channel, while still controlling the prompt sentences and post-processing locally. The feature-vector store may be implemented using different vector indexing algorithms. The emotion estimation model may be expanded to include multimodal transformers that jointly attend to audio and text tokens. The query context schema may be extended to store additional metadata such as device type or historical reliability scores. In all such variants, the server maintains the core functionality of generating prompt sentences to control a generative AI model, extracting attribute information and search parameters, executing combined searches, and using emotional state to govern both inner computational behavior and outer response style, so that the system yields improved technical performance in processing lost-item inquiries.

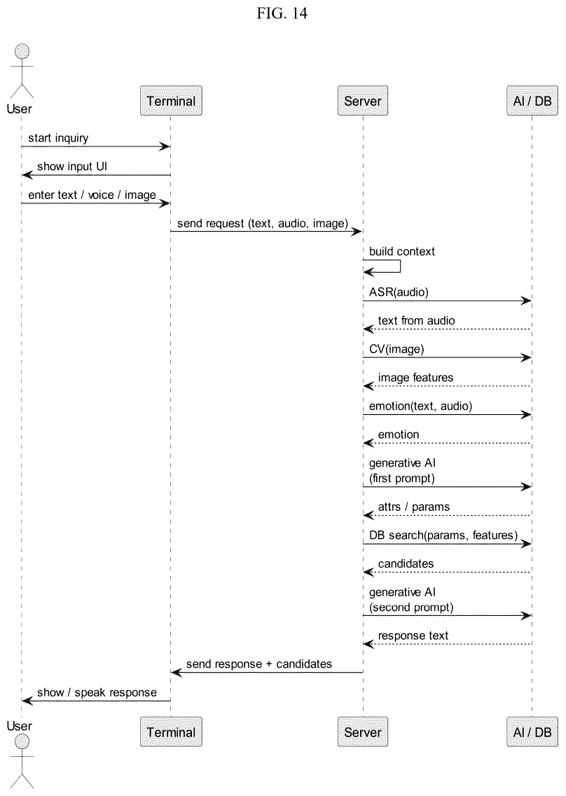

The following describes the processing flow using FIG. 14.

### Step 1:

User operates the terminal to initiate a lost-item inquiry or found-item registration.

User selects a function on the terminal application (for example, “Search for lost item” or “Register found item”) and chooses an input mode such as “Text only,” “Voice+Image,” or “Image only.”

Input: User actions on the graphical user interface (GUI).

Output: A selected mode and an initialized input screen on the terminal.

Terminal displays the appropriate input controls (text box, microphone button, camera button) and allocates memory buffers to store upcoming text, audio, and image data.

### Step 2:

User inputs text data describing the article.

User types a natural-language description into a text field, for example: “I forgot my red umbrella yesterday.”

Input: Key events or touch-screen inputs from the user.

Output: UTF-8 encoded text data stored in a local buffer on the terminal.

Terminal collects characters, performs basic normalization (for example, trimming whitespace), and stores the resulting string as part of a local inquiry object.

### Step 3:

User inputs audio data describing the article or expressing urgency.

User presses a “Record” button and speaks into the terminal's microphone, for example: “Please find this umbrella, I am in a hurry.”

Input: Analog voice signal captured by the microphone.

Output: Digitized audio data (for example, a WAV or compressed audio stream) stored in a local buffer.

Terminal samples the audio at a predetermined rate, encodes it into a digital format, and associates the resulting audio file with the same inquiry object that holds the text data.

### Step 4:

User captures image data of the article.

User presses a “Camera” button and points the terminal's camera at the article, such as an umbrella or wallet, and confirms the captured image.

Input: Light captured by the camera's image sensor.

Output: Image data (for example, a JPEG file) stored in a local buffer.

Terminal activates the camera hardware, converts raw sensor data into an encoded image format, reduces resolution if necessary, and associates the image file with the inquiry object.

### Step 5:

Terminal prepares and sends a request to the server.

Terminal collects the text data, audio data, image data, and metadata (for example, timestamp, store identifier, user identifier) and creates a structured request message.

Input: Local inquiry object containing text, audio, image, and metadata.

Output: An HTTP or HTTPS request message transmitted to the server.

Terminal serializes the text into JSON, attaches the audio and image as multipart binary sections, encrypts the communication channel using a transport-level security protocol, and sends the request to a predefined server API endpoint.

### Step 6:

Server receives and validates the request.

Server listens on the network interface, accepts the request from the terminal, and parses the headers and body.

Input: HTTP or HTTPS request containing text, audio, image, and metadata.

Output: A validated internal request object and a stored raw log entry.

Server authenticates the request (for example, by verifying a token), checks content types and size limits, stores a raw copy in a log table, and constructs an internal request object containing pointers or references to the uploaded data.

### Step 7:

Server constructs an initial query context.

Server allocates a query context structure and populates it with the user's raw text, references to the audio and image data, and metadata such as session identifier and timestamp.

Input: Internal request object from Step 6.

Output: Initialized query context stored in a session store.

Server assigns a unique context identifier, initializes fields such as “manual_text,” “audio_text,” “image_features,” “emotion_state,” and stores the structure in memory or a key-value store for subsequent processing.

### Step 8:

Server performs speech recognition to convert audio data into text.

Server sends the audio data or a reference to it to a speech recognition engine and obtains a text transcription.

Input: Audio data or audio reference from the query context.

Output: Converted text data representing spoken content.

Server segments the audio into frames, extracts acoustic features (for example, Mel-frequency features), passes them through an acoustic model and language model, receives token sequences, and joins them into a natural-language string such as “Please find this umbrella, I am in a hurry.”

### Step 9:

Server integrates speech-derived text into the query context.

Server merges the converted text from the audio with the manually entered text to form a complete verbal description of the inquiry.

Input: Manual text data and converted text data from speech recognition.

Output: Updated “inquiry content” field in the query context.

Server concatenates the strings, optionally tags segments by source (manual vs. audio), normalizes punctuation, and updates the query context so that downstream modules can treat the combined text as the canonical inquiry content.

### Step 10:

Server performs image analysis to extract visual features.

Server sends the image data to an image analysis engine and requests object labels, color information, and a feature vector.

Input: Image data or image reference from the query context.

Output: Feature information including object information, color labels, and a high-dimensional feature vector.

Server resizes and normalizes the image, feeds it into a convolutional or transformer-based vision network, obtains class probabilities for object categories (for example, “umbrella”), estimates dominant colors (for example, “red”), and reads out an intermediate layer as a feature vector; server then stores these results in the “image_features” field of the query context.

### Step 11:

Server estimates the user's emotional state.

Server analyzes the inquiry content and optionally prosodic features from the audio to infer the user's emotional state.

Input: Combined text content from Step 9 and possibly audio-derived prosodic features.

Output: An emotional state classification and associated confidence scores.

Server encodes the text using a text encoder network to obtain an embedding, optionally concatenates this with prosody features (pitch, energy, speaking rate), feeds the result into an emotion classifier, computes probabilities for categories such as sadness, anxiety, or neutrality, and stores the most probable category and its score in the “emotion_state” field of the query context.

### Step 12:

Server generates a first prompt sentence for the generative AI model.

Server constructs a textual instruction to cause the generative AI model to extract attribute information and search parameters from the inquiry content and image labels.

Input: Query context fields including inquiry content and image-derived labels.

Output: A first prompt sentence in natural language.

Server formats a prompt such as:

“Extract structured attributes from the following lost-item query.

Query text: ‘I forgot my red umbrella yesterday. Please find this umbrella, I am in a hurry.’

Image labels: {umbrella, red, folding}.

Return item_type, color, date_reference, and urgency_level.”

Server stores this prompt in memory and prepares it as input tokens to the generative AI model.

### Step 13:

Server calls the generative AI model to extract attributes and search parameters.

Server feeds the first prompt sentence and related context into the generative AI model and obtains a structured textual output.

Input: First prompt sentence and tokenized inquiry context.

Output: A model-generated text describing attribute information and search parameters.

Server tokenizes the prompt, passes the token sequence through the transformer-based generative AI model, allows the model to generate output tokens under configured decoding parameters (for example, temperature, maximum length), decodes the tokens back to text, and obtains a result such as “item_type: umbrella; color: red; date_reference: yesterday; urgency_level: high.”

### Step 14:

Server parses the generated attributes and search parameters.

Server converts the generative AI model's textual output into a structured internal representation for search.

Input: Text output from the generative AI model in Step 13.

Output: Search parameters object containing item type, color, temporal information, and urgency.

Server applies pattern matching or a lightweight parser to identify keys and values, maps temporal expressions such as “yesterday” into an absolute date using the current system time, and normalizes urgency expressions into a numeric priority score; server then stores this search parameter object in the query context.

### Step 15:

Server performs a text-based search in the lost-article database.

Server uses the search parameters to construct and execute a database query against stored lost-article records.

Input: Search parameters object from Step 14 and lost-article database contents.

Output: A set of candidate records matching the textual conditions.

Server generates a query that filters by article category, color, date range, and location, submits the query to the relational database engine, receives result rows containing article identifiers and metadata, and stores this preliminary candidate list in the query context.

### Step 16:

Server performs a similarity search based on the feature vector.

Server compares the image feature vector from the query context with stored feature vectors to find visually similar articles.

Input: Query image feature vector and stored feature vectors in the feature-vector store.

Output: A ranked list of article identifiers with similarity scores.

Server queries a vector index, computes similarity metrics between the query vector and stored vectors, retrieves nearest neighbors, and assigns similarity scores; server records a list of candidate article identifiers and their scores in the query context.

### Step 17:

Server combines text-based and feature-vector search results.

Server merges the candidate lists from text-based search and vector similarity search to identify final candidate lost articles.

Input: Text-based candidate list and similarity-based candidate list.

Output: A unified ranked list of candidate lost articles with overall relevance scores.

Server joins the two lists on article identifiers, calculates an overall score as a weighted combination of text match score and visual similarity score (weights may depend on urgency or confidence), sorts the unified list in descending order of overall score, and stores the top N candidates in the query context.

### Step 18:

Server adjusts search priority and range based on emotional state and urgency.

Server uses the emotional state and urgency level to decide whether to broaden the search and to allocate more computational resources.

Input: Emotional state from Step 11 and search parameters from Step 14.

Output: Modified search configuration and, optionally, updated candidate list.

Server checks whether the emotional state indicates high anxiety or urgency; if so, server can expand the temporal window, include adjacent locations, or re-run the search with relaxed filters and additional neighbors from the vector index; server then updates the candidate list in the query context accordingly.

### Step 19:

Server generates a second prompt sentence for response generation.

Server constructs a new textual instruction that directs the generative AI model to create a natural-language response incorporating the candidate articles and emotional state.

Input: Query context containing inquiry content, emotional state, and candidate list.

Output: A second prompt sentence specifying response content and style.

Server composes a prompt such as:

“You are a support assistant in a physical store.

User message: ‘I forgot my red umbrella yesterday.’ Detected emotion: sadness (0.86). Urgency: high.

Database result: one red umbrella found yesterday at Entrance A, article_id 12345, currently stored at the information desk, pickup requires identification and a short description.

Task: Generate a short, polite, and reassuring response in English.
1) Acknowledge that the user lost a red umbrella.
2) Clearly tell the user where to go and what to bring.
3) Use a gentle and encouraging tone.”

Server stores this second prompt as input for the generative AI model.

### Step 20:

Server calls the generative AI model to generate a natural-language response.

Server sends the second prompt sentence to the generative AI model and receives a response text.

Input: Second prompt sentence from Step 19.

Output: Natural-language response text tailored to the user.

Server tokenizes the prompt, runs it through the generative AI model, generates an output sequence, decodes it into text such as “You mentioned that you lost a red umbrella yesterday. A red umbrella that matches your description was found at Entrance A and is now kept at the information desk. Please bring your identification and a brief description of the umbrella, and our staff will help you. Do not worry, we will do our best to make sure it is safely returned to you.”, and stores this text in the query context.

### Step 21:

Server post-processes and packages the response.

Server verifies the generated text for required information and assembles a response message for the terminal.

Input: Generated response text and candidate article data.

Output: A structured response payload ready for transmission.

Server checks that the response includes essential elements such as location and instructions, truncates the text if it exceeds predefined length limits, attaches metadata (article identifiers, storage locations, opening hours), and constructs a response object for the terminal.

### Step 22:

Server sends the response to the terminal.

Server transmits the structured response payload over the network to the terminal that initiated the inquiry.

Input: Response payload from Step 21 and terminal network address.

Output: Network message containing response text and metadata.

Server serializes the payload into a response format such as JSON, sends it using HTTP or HTTPS, and logs the completion status in the session store.

### Step 23:

Terminal receives and displays the response.

Terminal parses the received payload and presents the information to the user.

Input: Network response message from the server.

Output: Displayed text, optional audio playback, and visualized metadata on the terminal.

Terminal decodes the JSON, renders the response text on the screen, optionally invokes a text-to-speech engine to read the message aloud, and shows key fields such as “Entrance A-information desk” and opening hours; the terminal then returns to an interaction state where the user can ask follow-up questions or terminate the session.

### Step 24:

User acts on the provided information or continues the dialogue.

User reads or listens to the response and decides on a physical action (for example, going to the indicated location) or provides follow-up queries through the terminal.

Input: Displayed response and the user's understanding of it.

Output: User actions such as physical movement to the storage location or additional input to the terminal.

User may enter further questions like “Can you tell me exactly how to get to Entrance A?” or “Also, have you found a blue wallet?”; the terminal then collects this new input and the overall process can repeat from appropriate earlier steps with the existing query context.

The data generation model 58 is a so-called generative artificial intelligence (AI). Examples of the data generation model 58 include generative Als such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

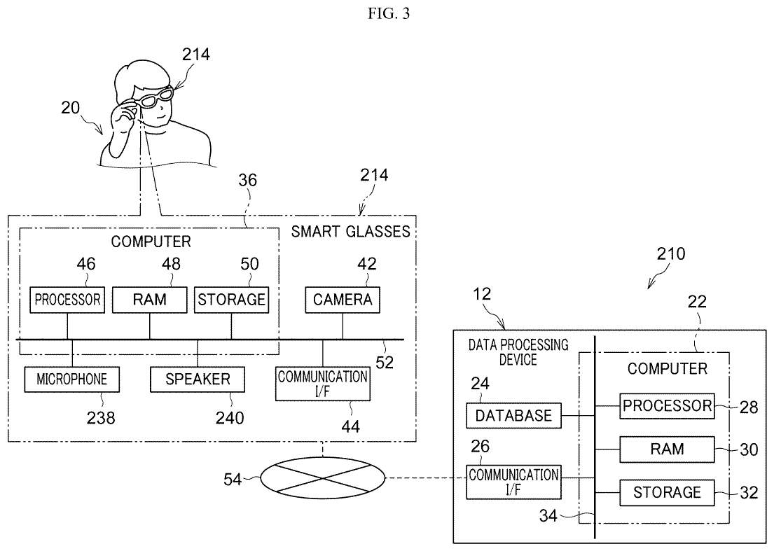

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

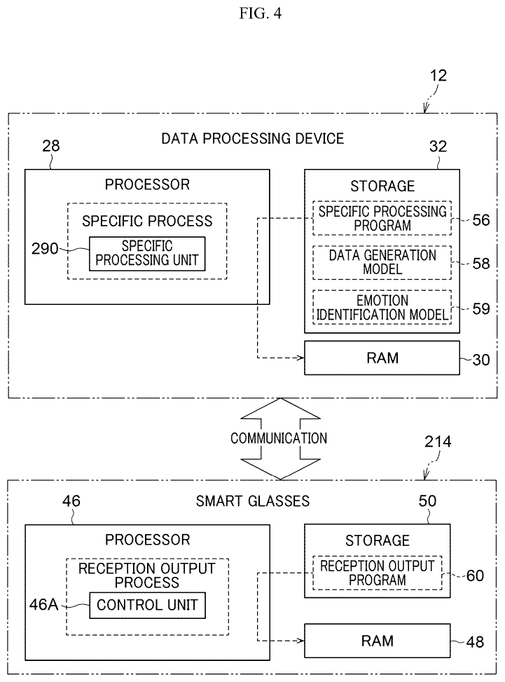

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative Als such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

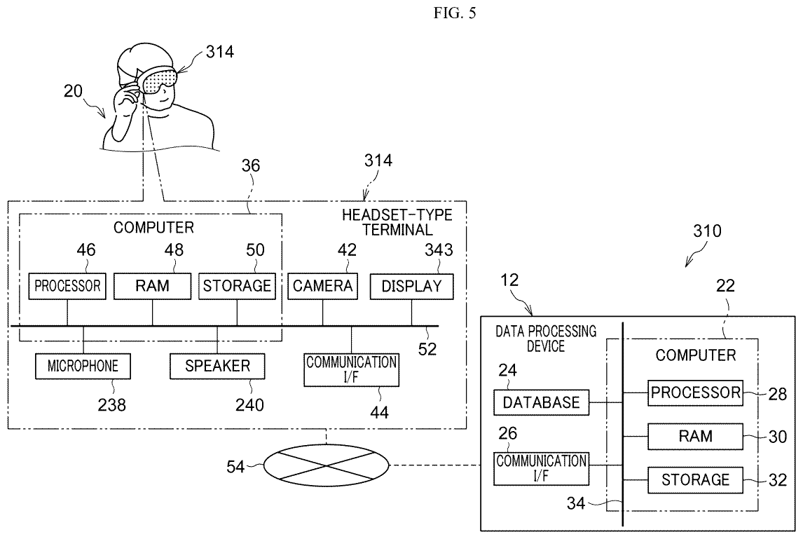

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

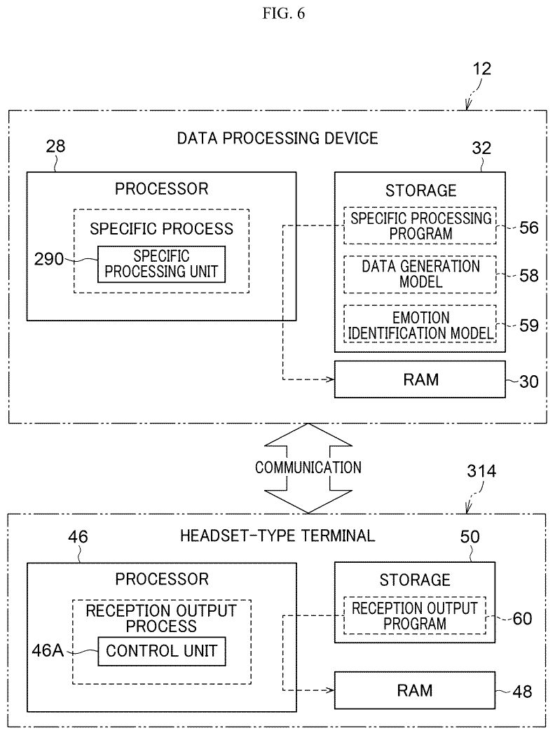

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

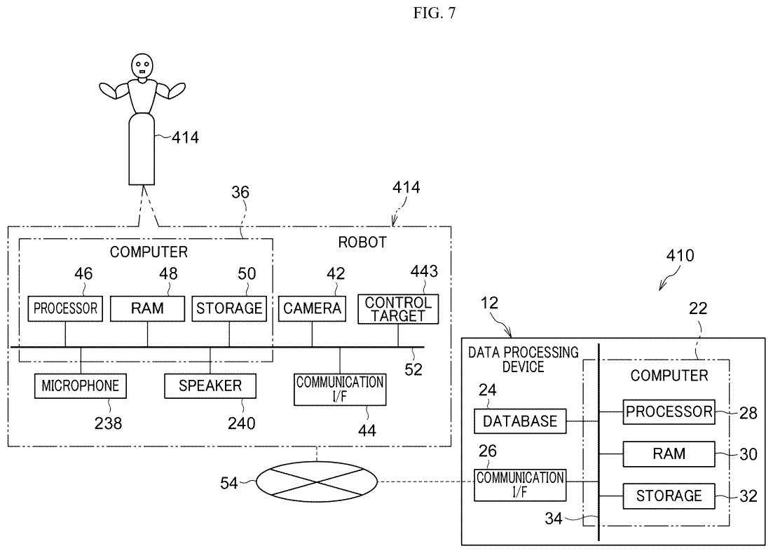

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

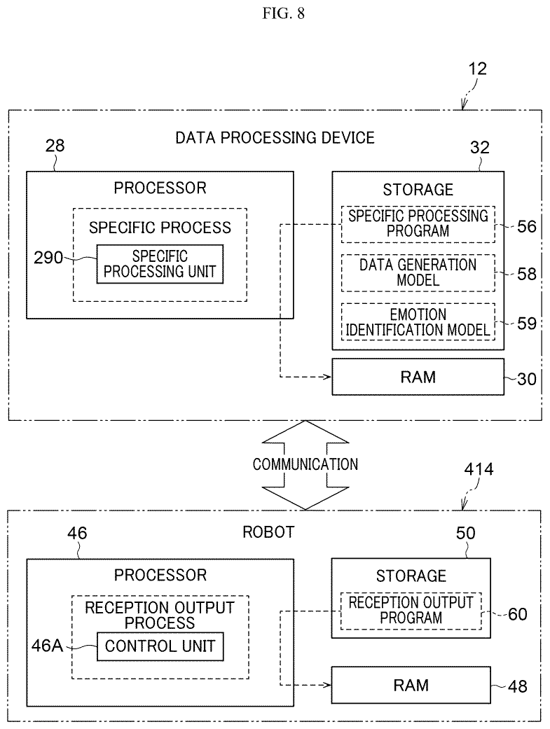

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative Als such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

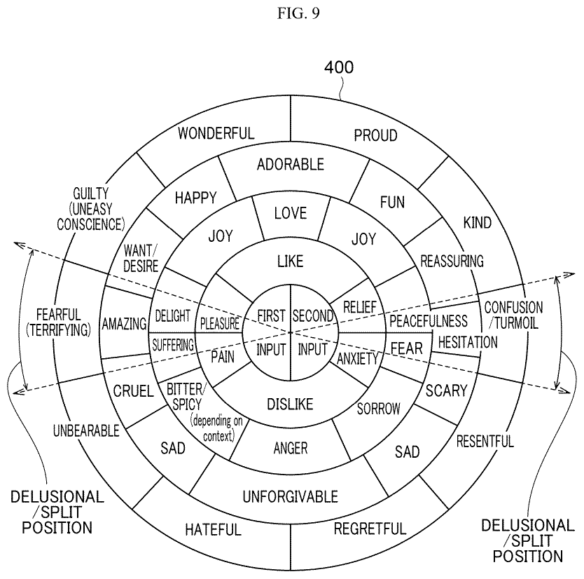

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University). Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more” and “want to know more” is experienced.

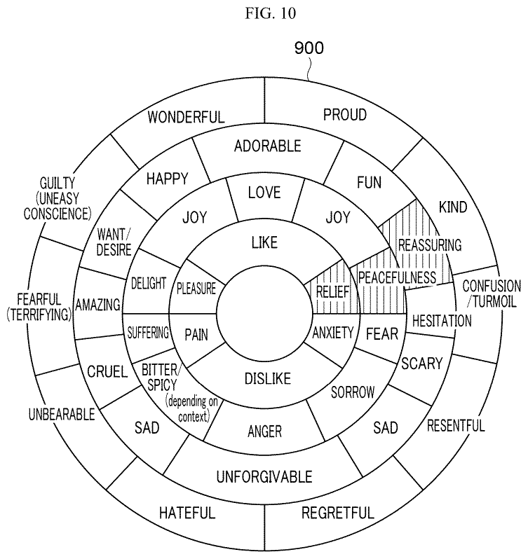

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (Saas).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### Example 1

### (Supplementary 1)

A system comprising a processor,
wherein the processor is configured to
receive, via a communication terminal, inquiry data in natural language, voice data, or image data from a user, and to obtain text data corresponding to the inquiry data, and
use a generative artificial intelligence model by generating a prompt sentence based on the text data, or based on text data generated from the voice data and the image data, the prompt sentence instructing the generative artificial intelligence model to extract date information, article category information, color information, place information, and feature information from contents of the inquiry, and provide an input including the prompt sentence to the generative artificial intelligence model to obtain structured information including the date information, the article category information, the color information, the place information, and the feature information, and
generate search conditions for a found-article management database based on the structured information, generate an inquiry statement corresponding to the search conditions, and search found-article information stored in the found-article management database based on the inquiry statement, and
generate response information in a user-recognizable format based on the searched found-article information, and provide the response information to the user via the communication terminal, and
when the voice data is input, perform speech recognition on the voice data using a voice processing technique to generate the text data, and when the image data is input, extract attribute information indicating an article category, a color, and appearance features from the image data using an image processing technique, and add the attribute information to input information for the generative artificial intelligence model, and
generate a prompt sentence for generating a description text or a summary text in natural language in response to the inquiry of the user, based on the structured information obtained from the generative artificial intelligence model and the found-article information obtained from the found-article management database, and cause the generative artificial intelligence model to generate a response using the prompt sentence.

### (Supplementary 2)

The system according to supplementary 1,
wherein the processor is configured to
normalize the date information included in the structured information obtained from the generative artificial intelligence model into absolute date-time information, based on a server time and time zone information, when the date information is expressed as a relative time expression, and use the normalized absolute date-time information as part of the search conditions for the found-article management database.

### (Supplementary 3)

The system according to supplementary 1,
wherein the processor is configured to
generate, when providing the prompt sentence to the generative artificial intelligence model, a unified inquiry text by integrating at least one of the text data obtained from the user, the text data generated by the voice processing technique, and an explanatory text including the attribute information extracted by the image processing technique, and use the unified inquiry text in the prompt sentence to improve extraction accuracy of the structured information by the generative artificial intelligence model.

### Application Example 1

### (Supplementary 1)

A system comprising a processor,
wherein the processor is configured to
receive, from a user terminal, inquiry information expressed in natural language, audio information, and image information,
generate and transmit, to a generative information processing apparatus including a generative AI model, a prompt sentence based on text information obtained by integrating the inquiry information expressed in natural language and a speech recognition result obtained from the audio information, and acquire structured keyword information output from the generative AI model,
execute image recognition processing on the image information to acquire visual attribute information including object category information and color information, integrate the structured keyword information and the visual attribute information, based on attribute priority rules and complement rules, to generate integrated keyword information for searching a found-item record,
convert a date expression included in the integrated keyword information into a concrete calendar date or time range based on a reference date and time,
execute a search process on an information storage apparatus in which found-item information is stored, based on the integrated keyword information and the converted calendar date or time range, and acquire candidate found-item information,
perform similarity evaluation and ranking processing on the candidate found-item information based on a degree of match with the integrated keyword information,
generate and transmit, to the generative AI model, a prompt sentence for response generation based on the candidate found-item information and the inquiry information expressed in natural language, and acquire a natural language response message for presentation to a user from the generative AI model, and
transmit the natural language response message and the candidate found-item information to the user terminal.

### (Supplementary 2)

The system according to supplementary 1,
wherein the processor is configured to
normalize, in the structured keyword information acquired from the generative AI model, item category information, color information, location information, and time information into standardized attribute formats, and automatically generate search conditions for the information storage apparatus based on the standardized attribute formats.

### (Supplementary 3)

The system according to supplementary 1,
wherein the processor is configured to
when the visual attribute information acquired from the image information conflicts with the structured keyword information acquired from the generative AI model, select, for each attribute, either adoption or coexistence of the attributes based on a reliability associated with each attribute, and generate the integrated keyword information based on a result of the selection.

### Example 2

### (Supplementary 1)

A system comprising a processor,
wherein the processor is configured to
receive, via a terminal, voice information or image information transmitted as an inquiry from a user, and store the voice information or the image information as inquiry session information, perform, for the voice information, a conversion process into text information by using a speech recognition processing apparatus, and perform, for the image information, a processing of extracting object attribute information and feature quantity information by using an image recognition processing apparatus,
generate, on the basis of the text information, the object attribute information, and the feature quantity information, a prompt sentence to be input to a generative AI model, and obtain structured inquiry information from the generative AI model and generate a search condition for a lost-article management database based on the structured inquiry information,
search, on the basis of the search condition, lost-article information stored in the lost-article management database, identify a plurality of candidate lost-article information items by an extraction process including a similarity calculation using the feature quantity information, and generate presentation explanation information for the user by using the generative AI model with respect to the candidate lost-article information items, and
transmit the presentation explanation information and the candidate lost-article information items to the terminal, and output the presentation explanation information and the candidate lost-article information items, via the terminal, as a lost-article identification result to the user.

### (Supplementary 2)

The system according to supplementary 1,
wherein the processor is configured to
acquire, via the terminal, additional voice information or image information transmitted as an additional inquiry from the user in association with the inquiry session information, update the prompt sentence and the search condition on the basis of the additional voice information or the additional image information, and re-search the lost-article management database on the basis of the updated search condition so as to progressively improve accuracy of the lost-article identification result.

### (Supplementary 3)

The system according to supplementary 1,
wherein the processor is configured to
input, to the generative AI model, a prompt sentence including the candidate lost-article information items and contents of the inquiry from the user, obtain response generation information from the generative AI model, calculate an evaluation value for evaluating importance of each of the candidate lost-article information items on the basis of the response generation information, and rank the candidate lost-article information items and control a presentation order thereof on the basis of the evaluation value.

### Application Example 2

### (Supplementary 1)

A system comprising a processor,
wherein the processor is configured to
receive, from a terminal operated by a user, text data, audio data, and image data, and store a query context including an inquiry content composed of the text data and the audio data,
generate a first prompt sentence for a generative AI model including a natural language processing model, based on the query context and the image data, and cause the generative AI model, according to the first prompt sentence, to extract attribute information of a lost article and search parameters from the inquiry content and the image data,
perform speech recognition processing on the audio data to convert the audio data into converted text data, and update the query context by integrating the converted text data with the text data, as a speech processing,
perform image analysis processing on the image data to extract feature information including object information, color information, and a feature vector, as an image processing,
search storage containing lost-article information based on the search parameters extracted by the generative AI model and the feature information, and identify candidate lost articles by combining a text-based search and a similarity search based on the feature vector,
estimate an emotional state of the user based on at least one of the query context, the audio data, and the text data, generate a second prompt sentence for response generation for the generative AI model using a response-generation context including the emotional state and a search result of the candidate lost articles, and cause the generative AI model, according to the second prompt sentence, to generate a natural language response to be presented to the user,
dynamically control at least one of a search priority and a search range for the candidate lost articles according to the estimated emotional state and the search parameters, and
transmit the natural language response and information relating to the candidate lost articles to the terminal for provision to the user.

### (Supplementary 2)

The system according to supplementary 1,
wherein the processor is configured to include, in the second prompt sentence for the generative AI model, instruction information specifying at least one of a writing style, a politeness level, and a degree of encouragement corresponding to the emotional state of the user, so as to cause the generative AI model to generate a natural language response adapted to the emotional state of the user.

### (Supplementary 3)

The system according to supplementary 1,
wherein the processor is configured to include, in at least one of the first prompt sentence and the second prompt sentence for the generative AI model, past inquiry history and search result history relating to the candidate lost articles, so as to cause the generative AI model to generate a guidance response regarding the lost article based on a continuous dialogue context.

What is claimed is:

1. A system comprising:
circuitry configured to:
receive, via a communication interface coupled to a packet-switched network, query data comprising at least one of text data, audio data, or image data from a terminal device;
perform speech recognition processing on the audio data to convert the audio data into converted text data, and perform image analysis processing on the image data to extract visual attribute information comprising at least object category information, color information, and a feature vector;
generate a first prompt sentence based on integrated text information obtained by combining the text data and the converted text data, input the first prompt sentence to a generative neural network model, and obtain from the generative neural network model structured attribute data comprising date information, category information, color information, location information, and feature information;
generate search conditions for an article record storage based on the structured attribute data and the visual attribute information, execute a search process on the article record storage, and identify candidate article records by combining a text-based search and a similarity search based on the feature vector;
generate a second prompt sentence based on the candidate article records and the query data, input the second prompt sentence to the generative neural network model, and obtain from the generative neural network model a natural language response for presentation to a user; and
transmit a notification data packet comprising the natural language response and the candidate article records to the terminal device via the communication interface.

2. The system according to claim 1, wherein the circuitry is configured to normalize date information included in the structured attribute data, when expressed as a relative time expression, into an absolute date-time value based on a reference date and time zone information, and to use the absolute date-time value as part of the search conditions.

3. The system according to claim 2, wherein the circuitry is configured to normalize the category information, the color information, and the location information in the structured attribute data into standardized attribute formats, and to automatically generate the search conditions based on the standardized attribute formats.

4. The system according to claim 1, wherein the image analysis processing comprises applying an object detection model to the image data to extract the object category information and the color information, and applying a feature extraction model to the image data to compute the feature vector as a multi-dimensional numerical representation.

5. The system according to claim 4, wherein the circuitry is configured to, when the visual attribute information extracted from the image data conflicts with the structured attribute data obtained from the generative neural network model, select for each attribute either adoption or coexistence of conflicting attributes based on a reliability value associated with each attribute.

6. The system according to claim 1, wherein the generative neural network model comprises a transformer-based architecture including multiple self-attention layers and feed-forward layers, and wherein the circuitry is configured to control at least one of a temperature parameter or a top-k sampling threshold during generation of the structured attribute data.

7. The system according to claim 1, wherein the circuitry is configured to perform similarity evaluation on the candidate article records by computing a distance metric between the feature vector extracted from the image data and stored feature vectors associated with article records in the article record storage, and to rank the candidate article records based on the distance metric.

8. The system according to claim 7, wherein the circuitry is configured to calculate an evaluation value for each candidate article record based on a degree of match with the structured attribute data and the visual attribute information, and to control a presentation order of the candidate article records based on the evaluation value.

9. The system according to claim 1, wherein the circuitry is configured to estimate an emotional state of the user based on at least one of the audio data, the text data, or the converted text data, and to include in the second prompt sentence instruction information specifying at least one of a writing style, a politeness level, or a degree of encouragement corresponding to the estimated emotional state.

10. The system according to claim 9, wherein the circuitry is configured to dynamically control at least one of a search priority or a search range for the candidate article records based on the estimated emotional state.

11. The system according to claim 1, wherein the circuitry is configured to generate a unified inquiry text by integrating at least one of the text data, the converted text data, and an explanatory text including the visual attribute information, and to use the unified inquiry text in the first prompt sentence.

12. The system according to claim 1, wherein the circuitry is configured to receive, from the terminal device, additional query data comprising at least one of additional audio data or additional image data, update the first prompt sentence and the search conditions based on the additional query data, and re-execute the search process on the article record storage to progressively improve accuracy of the candidate article records.

13. The system according to claim 1, wherein the circuitry is configured to include, in at least one of the first prompt sentence and the second prompt sentence, past inquiry history and search result history, and to cause the generative neural network model to generate the natural language response based on a continuous dialogue context.

14. The system according to claim 1, wherein the circuitry is configured to store, in the article record storage, session information associating the query data, the structured attribute data, and the candidate article records with a session identifier for the user.

15. The system according to claim 1, wherein the speech recognition processing comprises applying an acoustic model to the audio data to generate phoneme-level representations and applying a language model to the phoneme-level representations to generate the converted text data.

16. The system according to claim 1, wherein the circuitry is configured to generate a description text for each candidate article record by inputting to the generative neural network model a prompt sentence comprising attributes of the candidate article record, and to include the description text in the notification data packet transmitted to the terminal device.

17. The system according to claim 1, wherein the circuitry is configured to receive the query data from a wearable information display apparatus serving as the terminal device, and to transmit the notification data packet to the wearable information display apparatus for display as visual information superimposed on a display unit of the wearable information display apparatus.

18. A system comprising:
circuitry configured to:
receive, via a communication interface coupled to a packet-switched network, query data comprising text data, audio data, and image data from a terminal device;
perform speech recognition processing on the audio data to generate converted text data, perform image analysis processing on the image data to extract visual attribute information comprising object category information, color information, and a feature vector, and generate a unified inquiry text by integrating the text data, the converted text data, and an explanatory text derived from the visual attribute information;
input a first prompt sentence comprising the unified inquiry text to a generative neural network model comprising a transformer-based architecture to obtain structured attribute data, normalize date information in the structured attribute data into an absolute date-time value, and resolve conflicts between the visual attribute information and the structured attribute data based on reliability values;
generate search conditions based on the structured attribute data and the visual attribute information, execute a text-based search and a similarity search on an article record storage, rank candidate article records based on a degree of match, and estimate an emotional state of the user based on at least one of the audio data or the text data;
generate a second prompt sentence comprising the candidate article records, the query data, and instruction information corresponding to the estimated emotional state, input the second prompt sentence to the generative neural network model, and obtain a natural language response; and
transmit, via the communication interface, a notification data packet comprising the natural language response and the candidate article records to the terminal device.

19. The system according to claim 18, wherein the circuitry is configured to receive additional query data from the terminal device, update the first prompt sentence and the search conditions based on the additional query data and past inquiry history, re-execute the search process on the article record storage, and transmit an updated natural language response and updated candidate article records to the terminal device.

20. A method comprising:
receiving, via a communication interface coupled to a packet-switched network, query data comprising at least one of text data, audio data, or image data from a terminal device;
performing speech recognition processing on the audio data to convert the audio data into converted text data, and performing image analysis processing on the image data to extract visual attribute information comprising at least object category information, color information, and a feature vector;
generating a first prompt sentence based on integrated text information obtained by combining the text data and the converted text data, inputting the first prompt sentence to a generative neural network model, and obtaining from the generative neural network model structured attribute data comprising date information, category information, color information, location information, and feature information;
generating search conditions for an article record storage based on the structured attribute data and the visual attribute information, executing a search process on the article record storage, and identifying candidate article records by combining a text-based search and a similarity search based on the feature vector;
generating a second prompt sentence based on the candidate article records and the query data, inputting the second prompt sentence to the generative neural network model, and obtaining from the generative neural network model a natural language response for presentation to a user; and
transmitting a notification data packet comprising the natural language response and the candidate article records to the terminal device via the communication interface.
